(19) United States
(12) Patent Application Publication
(10) Pub. No.: US 2025/0039862 A1
(43) Pub. Date: Jan. 30, 2025

(54) RESOURCE BLOCK SCHEDULING METHOD, AND ELECTRONIC DEVICE PERFORMING SAME METHOD

(71) Applicants: Samsung Electronics Co., Ltd., Suwon-si (KR); Korea University Research and Business Foundation, Seoul (KR)

(72) Inventors: Hyungtae KWON, Suwon-si (KR); Inkyu LEE, Seoul (KR); Hongju LEE, Seoul (KR); Sangeon KIM, Suwon-si (KR); Seunghyun MIN, Suwon-si (KR)

(21) Appl. No.: 18/912,933

(22) Filed: Oct. 11, 2024

Related U.S. Application Data
(63) Continuation of application No. PCT/KR2023/004409, filed on Mar. 31, 2023.

(30) Foreign Application Priority Data
Apr. 12, 2022 (KR) 10-2022-0045298
May 4, 2022 (KR) 10-2022-0055224

(51) Int. Cl. H04W 72/121; H04W 72/542

(52) U.S. Cl. CPC H04W 72/121; H04W 72/542

(57) ABSTRACT

A resource block scheduling method and an electronic device performing the method are disclosed. An electronic device according to various embodiments may comprise: at least one processor, comprising processing circuitry, and a memory electrically connected to at least one processor and storing instructions executable by the processor, wherein at least one processor, individually and/or collectively, is configured to execute the instructions and to:

based on channel quality information indexes (CQIs) relating to a plurality of terminals, acquire achievable rates based on resource blocks being allocated to the plurality of terminals; and input the achievable rates to a trained neural network model to output a schedule for allocation of the resource blocks to the plurality of terminals, and the neural network model is configured to be trained to collect the training CQIs relating to the plurality of terminals, acquire, based on the training CQIs, training achievable rates based on the resource blocks being allocated to the plurality of terminals, and output the schedule, in which the sum of the rates for the plurality of terminals is maximized and fairness indexes for the plurality of terminals satisfy a configured fairness condition, using the input training achievable rates.

### CROSS-REFERENCE TO RELATED APPLICATIONS

This application is a continuation of International Application No. PCT/KR2023/004409, designating the United States, filed on Mar. 31, 2023, in the Korean Intellectual Property Receiving Office and claiming priority to Korean Patent Application No. 10-2022-0045298, filed on Apr. 12, 2022, in the Korean Intellectual Property Office and to Korean Patent Application No. 10-2022-0055224 filed on May 4, 2022, in the Korean Intellectual Property Office. The entire disclosures of each of which are incorporated by reference herein in their entireties.

### BACKGROUND

### Field

The disclosure relates to a resource block scheduling method and an electronic device performing the resource block scheduling method.

### Description of Related Art

Distribution of limited time-frequency resources to user equipment (UE), or user terminals, may require scheduling resource blocks (RBs) for the user terminals in various ways. In this case, the scheduling may be performed to allocate limited RBs to users based on data on channel environments and requirements between a base station and the users.

A failure in effective scheduling of RBs on a network may cause great latency for UE that requires a low-latency service or may lead to unfulfillment of a quality of service (QOS) of a user that requires high-capacity communication, degrading the overall communication quality of the network.

To allocate RBs, methods such as round-robin (RR) scheduling, best-channel quality indicator (CQI) scheduling, proportional fairness (PF) scheduling, or the like may be used. The RR scheduling may periodically allocate RBs to all users to allocate the same communication resources, ensuring fair resource allocation for all the users.

The best-CQI scheduling may allocate RBs to users with the best channel quality based on CQI (also “channel quality information (CQI)” herein) received from users according to each of the RBs. This scheduling method may allow users with the best channel environment to always have priority in scheduling, thereby achieving a high overall performance of the network.

The PF scheduling may allocate RBs to ensure that no user experiences degraded performance based on a trade-off between the overall performance of the network and the performance of individual users.

Scheduling resource blocks (RBs) for user terminals using a fixed algorithm may fail to allocate resources appropriately and respond appropriately to rapidly changing channel and network situations.

Allocating resources according to round-robin (RR) scheduling, best-channel quality indicator (CQI) scheduling, and proportional fairness (PF) scheduling may satisfy fairness for users, but may result in a low performance of each user and the entire network, a failure in satisfying fairness despite high performance of each user and the entire network, or a difficulty in responding immediately to a rapidly changing channel and network environment due to fixed parameter values.

### SUMMARY

Embodiments of the disclosure may provide a scheduling method and an electronic device performing the scheduling method, which may allocate RBs to user terminals such that a high overall system throughput is achieved and fairness for users is satisfied.

Embodiments of the disclosure may provide a scheduling method and an electronic device performing the scheduling method, which may allocate RBs to user terminals based on various environmental changes, such as, a change in a network environment or a channel environment.

Embodiments of the disclosure may provide a scheduling method, an electronic device performing the scheduling method, and a method of training a neural network model, which may allocate RBs to user terminals based on environmental changes and may increase a system throughput while satisfying fairness, using an artificial neural network (ANN).

According to various example embodiments, there is provided an electronic device including: at least one processor comprising processing circuitry; and a memory electrically connected to at least one processor and storing instructions executable by the processor. At least one processor, individually and/or collectively, may be configured to: obtain an achievable rate predicted based on resource blocks (RBs) being allocated to a plurality of terminals, based on channel quality information (CQI) indexes for the plurality of terminals; and output a schedule for allocating the RBs to the plurality of terminals by inputting the achievable rate into a trained neural network model. The neural network model may be trained to: collect training CQI indexes for the plurality of terminals; obtain a training achievable rate predicted when the RBs are allocated to the plurality of terminals based on the training CQI indexes; and output the schedule, using the training achievable rate input, such that a sum throughput for the plurality of terminals is maximized and a fairness index for the plurality of terminals satisfies a set fairness condition.

According to various example embodiments, there is provided an electronic device including: at least one processor comprising processing circuitry; and a memory electrically connected to the processor and storing instructions executable by the processor. at least one processor, individually and/or collectively, is configured to execute the instructions, and may be configured to: obtain, based on CQI indexes for a plurality of terminals, a current state including an average throughput of each of the plurality of terminals, a throughput, and an average fairness index for the plurality of terminals; and determine an action for allocating RBs to the plurality of terminals based on the current state, using a neural network model trained according to a deep Q-network (DQN) learning method. The neural network model may be trained to output the action that maximizes a reward in the current state, wherein the reward may be determined based on a reward function according to constraints set for allocating the RBs to the plurality of terminals.

According to various example embodiments, there is provided a scheduling method including: obtaining, based on CQI indexes for a plurality of terminals, a current state including an average throughput of each of the plurality of terminals, a throughput, and an average fairness index for the plurality of terminals; and determining an action for allocating RBs to the plurality of terminals based on the current state, using a neural network model trained according to a DQN learning method. The neural network model may be trained to output the action that maximizes a reward in the current state, and the reward may be determined based on a reward function according to constraints set for allocating the RBs to the plurality of terminals.

According to various example embodiments, there is provided a neural network model training method including: allocating RBs to a plurality of terminals for a set period of time and collecting training data including a current state, an action, a reward, and a subsequent state; determining a Q-value based on the training data input to a neural network model; and training the neural network model to output the action that provides a highest reward in the current state, using a loss calculated based on the Q-value. The reward may be determined based on a reward function according to set constraints for allocating the RBs to the plurality of terminals.

According to various example embodiments, the scheduling method and the electronic device performing the scheduling method may employ a supervised learning-based scheduling technique to learn an optimal solution of a predetermined (e.g., specified) high-complexity algorithm, significantly reducing execution complexity and facilitating efficient scheduling. In addition, the scheduling method and the electronic device performing the scheduling method may employ an unsupervised learning-based scheduling technique to learn given constraints without collecting training data and effectively schedule RBs to user equipment (UE).

According to various example embodiments, the scheduling method and the electronic device performing the scheduling method may employ a reinforcement learning-based algorithm (e.g., deep Q-network (DQN) and double DQN (DDQN)) to facilitate scheduling that, using a time-varying channel quality information (CQI) index, maximizes and/or increases an average transmission rate (or a “throughput” herein) while satisfying multiple constraints. It may enable scheduling while satisfying constraints that cannot be reflected in typical best-channel quality indicator (CQI) scheduling and round-robin (RR) scheduling algorithms, and it may also improve scheduling metrics while satisfying given fairness.

### BRIEF DESCRIPTION OF DRAWINGS

The above and other aspects, features and advantages of certain embodiments of the present disclosure will be more apparent from the following detailed description, taken in conjunction with the accompanying drawings, in which:

FIG. 1 is a block diagram illustrating an example electronic device in a network environment according to various embodiments;

FIG. 2 is a diagram illustrating an example operation performed by an electronic device to output a schedule according to various embodiments;

FIG. 3 is a flowchart illustrating an example scheduling method performed by an electronic device according to various embodiments;

FIG. 4 is a diagram illustrating an example operation performed by a training device to train a neural network model based on a supervised learning method according to various embodiments;

FIG. 5 is a diagram illustrating an example operation performed by a training device to train a neural network model based on an unsupervised learning method according to various embodiments;

FIG. 6 is a flowchart illustrating an example supervised learning-based neural network model training method performed by a training device according to various embodiments;

FIG. 7 is a flowchart illustrating an example unsupervised learning-based neural network model training method performed by a training device according to various embodiments;

FIG. 8 is a diagram illustrating an example network structure of a neural network model trained based on supervised learning according to various embodiments;

FIG. 9 is a diagram illustrating an example network structure of a neural network model trained based on unsupervised learning according to various embodiments;

FIG. 10 is a diagram illustrating an example activation function of a neural network model trained based on unsupervised learning according to various embodiments;

FIGS. 11A and 11B are graphs illustrating performance of an electronic device using a trained neural network model according to various embodiments;

FIG. 12 is a diagram illustrating an example operation performed by an electronic device to output an action according to various embodiments;

FIG. 13 is a flowchart illustrating an example scheduling method performed by an electronic device according to various embodiments;

FIG. 14 is a diagram illustrating an example operation performed by a training device to train a neural network model according to various embodiments;

FIG. 15 is a flowchart illustrating an example neural network model training method performed by a training device according to various embodiments;

FIG. 16 is a diagram illustrating an example operation performed by an electronic device to divide a plurality of terminals or resource blocks (RBs) into subgroups according to various embodiments; and

FIGS. 17A, 17B, and 17C are graphs illustrating performance of a trained neural network model according to various embodiments.

### DETAILED DESCRIPTION

Hereinafter, various example embodiments will be described in greater detail with reference to the accompanying drawings. When describing the various embodiments with reference to the accompanying drawings, like reference numerals refer to like elements and a description related thereto may not be repeated.

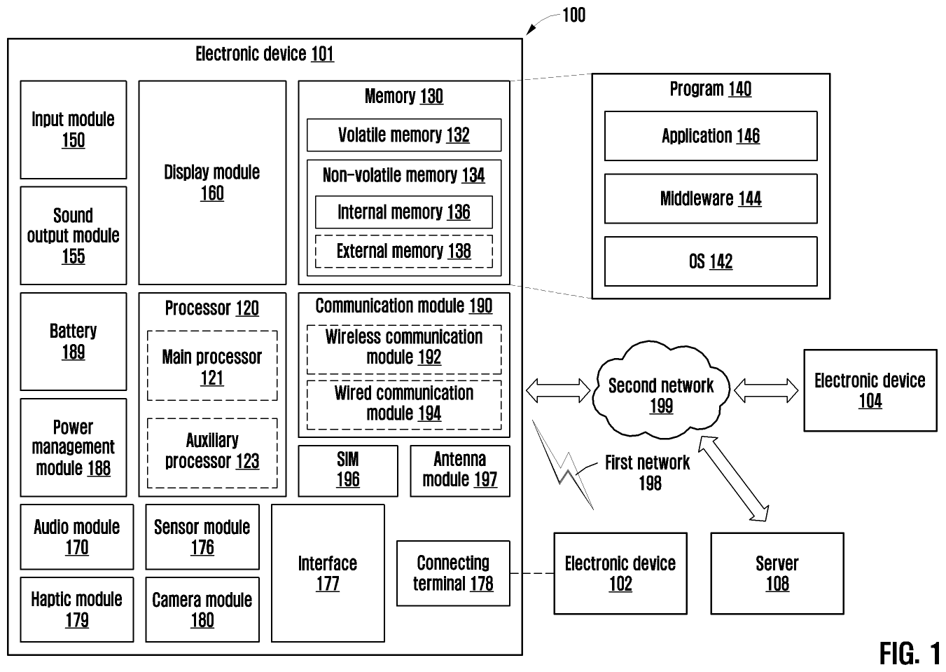

FIG. 1 is a block diagram illustrating an example electronic device 101 in a network environment 100 according to various embodiments. Referring to FIG. 1, the electronic device 101 in the network environment 100 may communicate with an electronic device 102 via a first network 198 (e.g., a short-range wireless communication network), or communicate with at least one of an electronic device 104 and a server 108 via a second network 199 (e.g., a long-range wireless communication network). The electronic device 101 may communicate with the electronic device 104 via the server 108. The electronic device 101 may include a processor 120, a memory 130, an input module 150, at least one sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In various embodiments, at least one (e.g., the connecting terminal 178) of the above components may be omitted from the electronic device 101, or one or more other components may be added to the electronic device 101. In various embodiments, some (e.g., the sensor module 176, the camera module 180, or the antenna module 197) of the components may be integrated as a single component (e.g., the display module 160).

The processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. The processor 120 may execute, for example, software (e.g., a program 140) to control at least one other component (e.g., a hardware or software component) of the electronic device 101 connected to the processor 120, and may perform various data processing or computation.

According to an embodiment, as at least a part of data processing or computation, the processor 120 may store a command or data received from another component (e.g., the sensor module 176 or the communication module 190) in a volatile memory 132, process the command or data stored in the volatile memory 132, and store resulting data in a non-volatile memory 134. The processor 120 may include a main processor 121 (e.g., a central processing unit (CPU) or an application processor (AP)) or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121 or to be specific to a specified function. The auxiliary processor 123 may be implemented separately from the main processor 121 or as a part of the main processor 121.

The auxiliary processor 123 may control at least some of functions or states related to at least one (e.g., the display module 160, the sensor module 176, or the communication module 190) of the components of the electronic device 101, instead of the main processor 121 while the main processor 121 is in an inactive (e.g., sleep) state or along with the main processor 121 while the main processor 121 is an active state (e.g., executing an application). The auxiliary processor 123 (e.g., an ISP or a CP) may be implemented as a portion of another component (e.g., the camera module 180 or the communication module 190) that is functionally related to the auxiliary processor 123. The auxiliary processor 123 (e.g., an NPU) may include a hardware structure specifically for artificial intelligence (AI) model processing. An AI model may be generated by machine learning. The learning may be performed by, for example, the electronic device 101, in which the AI model is performed, or performed via a separate server (e.g., the server 108). Learning algorithms may include, but are not limited to, for example, supervised learning, unsupervised learning, semi-supervised learning, or reinforcement learning. The AI model may include a plurality of artificial neural network layers. An artificial neural network may include, for example, a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network, or a combination of two or more thereof, but is not limited thereto. The AI model may alternatively or additionally include a software structure other than the hardware structure.

The memory 130 may store various pieces of data used by at least one component (e.g., the processor 120 or the sensor module 176) of the electronic device 101. The various pieces of data may include, for example, software (e.g., the program 140) and input data or output data for a command related thereto. The memory 130 may include the volatile memory 132 or the non-volatile memory 134.

The program 140 may be stored as software in the memory 130 and may include, for example, an operating system (OS) 142, middleware 144, or an application 146.

The input module 150 may receive, from outside (e.g., a user) the electronic device 101, a command or data to be used by another component (e.g., the processor 120) of the electronic device 101. The input module 150 may include, for example, a microphone, a mouse, a keyboard, a key (e.g., a button), or a digital pen (e.g., a stylus pen).

The sound output module 155 may output a sound signal to the outside of the electronic device 101. The sound output module 155 may include, for example, a speaker or a receiver. The speaker may be used for general purposes, such as playing multimedia or playing a recording. The receiver may be used to receive an incoming call. The receiver may be implemented separately from the speaker or as a part of the speaker.

The display module 160 may visually provide information to the outside (e.g., a user) of the electronic device 101. The display module 160 may include, for example, a display, a hologram device, or a projector, and control circuitry to control its corresponding one of the display, the hologram device, and the projector. The display module 160 may include a touch sensor adapted to sense a touch, or a pressure sensor adapted to measure an intensity of a force of the touch.

The audio module 170 may convert sound into an electric signal or vice versa. The audio module 170 may obtain the sound via the input module 150 or output the sound via the sound output module 155 or an external electronic device (e.g., the electronic device 102, such as a speaker or headphones) directly or wirelessly connected to the electronic device 101.

The sensor module 176 may detect an operational state (e.g., power or temperature) of the electronic device 101 or an environmental state (e.g., a state of a user) external to the electronic device 101 and generate an electric signal or data value corresponding to the detected state. The sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used by the electronic device 101 to couple with an external electronic device (e.g., the electronic device 102) directly (e.g., by wire) or wirelessly. The interface 177 may include, for example, a high-definition multimedia interface (HDMI), a universal serial bus (USB) interface, a secure digital

(SD) card interface, or an audio interface.

The connecting terminal 178 may include a connector via which the electronic device 101 may physically connect to an external electronic device (e.g., the electronic device 102). The connecting terminal 178 may include, for example, an HDMI connector, a USB connector, an SD card connector, or an audio connector (e.g., a headphones connector).

The haptic module 179 may convert an electric signal into a mechanical stimulus (e.g., a vibration or a movement) or an electrical stimulus, which may be recognized by a user via their tactile sensation or kinesthetic sensation. The haptic module 179 may include, for example, a motor, a piezoelectric element, or an electric stimulator.

The camera module 180 may capture a still image and moving images. The camera module 180 may include one or more lenses, image sensors, ISPs, and flashes.

The power management module 188 may manage power supplied to the electronic device 101. The power management module 188 may be implemented as, for example, at least a part of a power management integrated circuit (PMIC).

The battery 189 may supply power to at least one component of the electronic device 101. The battery 189 may include, for example, a primary cell, which is not rechargeable, a secondary cell, which is rechargeable, or a fuel cell.

The communication module 190 may support establishing a direct (e.g., wired) communication channel or a wireless communication channel between the electronic device 101 and an external electronic device (e.g., the electronic device 102, the electronic device 104, or the server 108) and performing communication via the established communication channel. The communication module 190 may include one or more CPs that are operable independently from the processor 120 (e.g., an AP) and that support direct (e.g., wired) communication or wireless communication. The communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device, for example, the electronic device 104, via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5th generation (5G) network, a next-generation communication network, the Internet, or a computer network (e.g., an LAN or a wide area network (WAN)). These various types of communication modules may be implemented as a single component (e.g., a single chip), or may be implemented as multiple components (e.g., multiple chips) separate from each other. The wireless communication module 192 may identify and authenticate the electronic device 101 in a communication network, such as the first network 198 or the second network 199, using subscriber information (e.g., international mobile subscriber identity (IMSI)) stored in the SIM 196.

The wireless communication module 192 may support a 5G network after a 4th generation (4G) network, and a next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., an mmWave band) to achieve, e.g., a high data transmission rate. The wireless communication module 192 may support various technologies for securing performance on a high-frequency band, such as, e.g., beamforming, massive multiple-input and multiple-output (MIMO), full dimensional MIMO (FD-MIMO), an array antenna, analog beamforming, or a large-scale antenna. The wireless communication module 192 may support various requirements specified in the electronic device 101, an external electronic device (e.g., the electronic device 104), or a network system (e.g., the second network 199). The wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., an external electronic device) of the electronic device 101. The antenna module 197 may include an antenna including a radiating element including a conductive material or a conductive pattern formed in or on a substrate (e.g., a printed circuit board (PCB)). The antenna module 197 may include a plurality of antennas (e.g., an antenna array). In such a case, at least one antenna appropriate for a communication scheme used in a communication network, such as the first network 198 or the second network 199, may be selected by, for example, the communication module 190 from the plurality of antennas. The signal or power may be transmitted or received between the communication module 190 and the external electronic device via the at least one selected antenna. According to an embodiment, another component (e.g., a radio frequency integrated circuit (RFIC)) other than the radiating element may be additionally formed as a part of the antenna module 197.

The antenna module 197 may form an mmWave antenna module. The mmWave antenna module may include a PCB, an RFIC on a first surface (e.g., a bottom surface) of the PCB or adjacent to the first surface of the PCB and capable of supporting a designated high-frequency band (e.g., a mmWave band), and a plurality of antennas (e.g., an antenna array) disposed on a second surface (e.g., a top or a side surface) of the PCB, or adjacent to the second surface of the PCB and capable of transmitting or receiving signals in the designated high-frequency band.

At least some of the components described above may be coupled mutually and exchange signals (e.g., commands or data) therebetween via an inter-peripheral communication scheme (e.g., a bus, general-purpose input and output (GPIO), serial peripheral interface (SPI), or mobile industry processor interface (MIPI)).

According to an embodiment, commands or data may be transmitted or received between the electronic device 101 and the external electronic device (e.g., the electronic device 104) via the server 108 coupled with the second network 199. Each of the external electronic devices (e.g., the electronic device 102 or 104) may be a device of the same type as or a different type from the electronic device 101. All or some operations to be executed by the electronic device 101 may be executed by one or more of the external electronic devices (e.g., the electronic devices 102 and 104 and the server 108). For example, if the electronic device 101 needs to perform a function or a service automatically, or in response to a request from a user or another device, the electronic device 101, instead of, or in addition to, executing the function or service, may request one or more external electronic devices to perform at least a part of the function or service. The one or more external electronic devices receiving the request may perform the at least part of the function or the service requested, or an additional function or an additional service related to the request and may transfer a result of the performance to the electronic device 101. The electronic device 101 may provide the result, with or without further processing of the result, as at least part of a response to the request. To that end, cloud computing, distributed computing, mobile edge computing (MEC), or client-server computing technology may be used, for example. The electronic device 101 may provide ultra-low latency services using, e.g., distributed computing or MEC. According to an embodiment, the external electronic device (e.g., the electronic device 104) may include an Internet-of-things (IoT) device. The server 108 may be an intelligent server using machine learning and/or a neural network. The external electronic device (e.g., the electronic device 104) or the server 108 may be included in the second network 199. The electronic device 101 may be applied to intelligent services (e.g., a smart home, a smart city, a smart car, or healthcare) based on 5G communication technology or IoT-related technology.

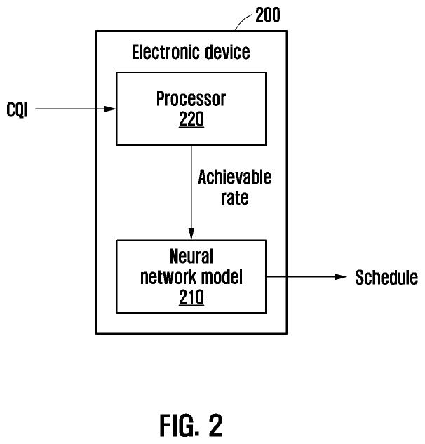

FIG. 2 is a diagram illustrating an example operation performed by an electronic device 200 (e.g., the electronic device 100 of FIG. 1) to output a schedule according to various embodiments.

Referring to FIG. 2, according to various embodiments, a processor (e.g., including processing circuitry) 220 (e.g., the processor 120 of FIG. 1) of the electronic device 200 may receive channel quality indicator (CQI) (or “channel quality information (CQI) indexes” herein) for a plurality of terminals. For example, the electronic device 200 may identify a distance to each of the plurality of terminals.

In an example, the processor 220 (e.g., the processor 120 of FIG. 1) of the electronic device 200 may obtain a transmission rate or throughput predicted when resource blocks (RBs) are allocated to the plurality of terminals, which is also referred to herein as an “achievable rate.” For example, the electronic device 200 may calculate the achievable rate for each user and RB based on a spectral efficiency that is based on a CQI index and a modulation coding scheme (MCS). For example, the spectral efficiency (or bandwidth efficiency) may refer to a transmission rate (or “throughput” herein) of a communication system for transmission over a given bandwidth.

In an example, the processor 220 of the electronic device 200 may calculate the spectral efficiency based on the CQI index and the MCS. Based on the spectral efficiency, the electronic device 200 may calculate the achievable rate predicted when an RB is allocated to each of the plurality of terminals based on the spectral efficiency.

In an example, the processor 220 of the electronic device 200 may input the achievable rate into a trained neural network model 210 to output a schedule for allocating the RBs to the plurality of terminals. For example, the electronic device 200 may allocate the RBs to the plurality of terminals according to the output schedule, and the plurality of terminals may perform communication based on the allocated RBs.

In an example, the neural network model 210 may be trained to output the schedule using an input training achievable rate. For example, the neural network model 210 may be trained to output the schedule such that a sum throughput for the plurality of terminals is maximized and a fairness index for the plurality of terminals satisfies a set fairness condition.

In this case, the processor 220 of the electronic device 200 may output the schedule using the trained neural network model 210, and the output schedule may thus maximize the sum throughput for the plurality of terminals and satisfy the set fairness condition. The electronic device 200 may allocate the RBs to the plurality of terminals according to the output schedule, increasing a system throughput while satisfying the fairness condition.

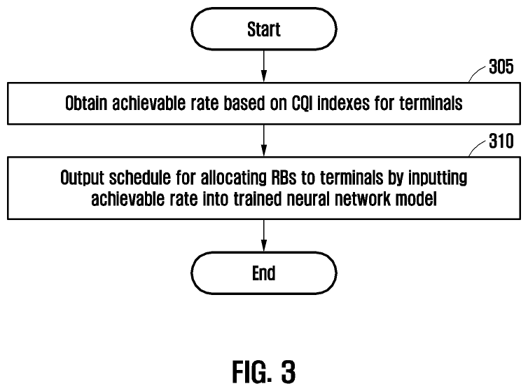

FIG. 3 is a flowchart illustrating an example scheduling method performed by an electronic device (e.g., the electronic device 200 of FIG. 2) according to various embodiments.

Referring to FIG. 3, according to various embodiments, at operation 305, the electronic device 200 may obtain an achievable rate based on CQI indexes for a plurality of terminals. For example, a processor (e.g., the processor 220 of FIG. 2) of the electronic device 200 may calculate an achievable rate for each terminal and RB based on a spectral efficiency based on a CQI index and an MCS.

For example, at operation 310, the electronic device 200 may output a schedule for allocating RBs to the plurality of terminals by inputting the achievable rate into a trained neural network model (e.g., the neural network model 210 of FIG. 2).

For example, the neural network model 210 may be trained to output the schedule that maximizes a sum throughput for the plurality of terminals and satisfies a set fairness condition. For example, allocating the RBs to the plurality of terminals to maximize the sum throughput and satisfy the set fairness condition may represent set constraints.

For example, the electronic device 200 may output the schedule that satisfies the set constraints using the neural network model 210 trained to output the schedule that satisfies the set constraints. For example, the electronic device 200 may allocate the RBs to the plurality of terminals according to the output schedule to increase the sum throughput of the entire network while improving fairness for each terminal.

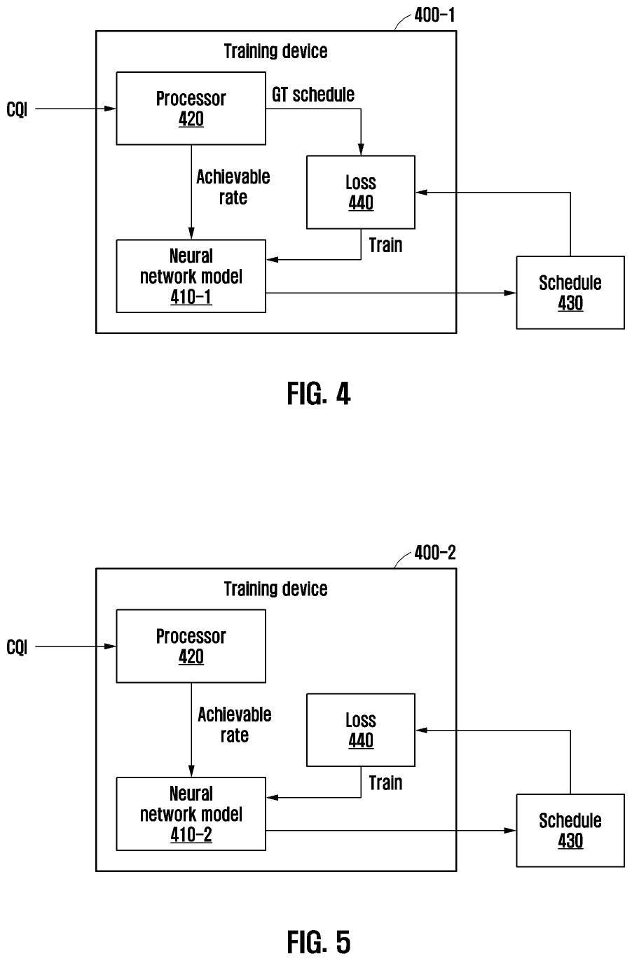

FIG. 4 is a diagram illustrating an example operation performed by a training device 400-1 to train a neural network model 410-1 based on a supervised learning method according to various embodiments.

In an example, as shown in FIG. 4, the training device 400-1 may train the neural network model 410-1 based on a supervised learning method. For example, the neural network model 210 used by the electronic device 200 of FIG. 2 may be the neural network model 410-1 trained by the training device 400-1 shown in FIG. 4.

In an example, the training device 400-1 may identify CQI indexes for a plurality of terminals using a processor 420 including processing circuitry (e.g., the processor 120 of FIG. 1). Using the CQI indexes, the processor 420 of the training device 400-1 may calculate an achievable rate predicted when RBs are allocated to the plurality of terminals. For example, the training device 400-1 may calculate the achievable rate in substantially the same way as the electronic device 200 of FIG. 2 performs.

For example, the CQI indexes collected by the training device 400-1 may be used to train the neural network model 410-1 and may thus be referred to as training CQI indexes. For example, the achievable rate calculated by the training device 400-1 may be used to train the neural network model 410-1 and may thus be referred to as a training achievable rate.

In an example, the training device 400-1 may use the training achievable rate to train the neural network model 410-1 to output a schedule such that a sum throughput for the plurality of terminals is maximized and a fairness index for the plurality of terminals satisfies a set fairness condition.

For example, scheduling that maximizes the sum throughput of the entire network for the plurality of terminals while ensuring fairness in throughputs of the plurality of terminals may represent allocating RBs to the plurality of terminals to satisfy Equation 1 below.

$${max}_{X} {\sum }_{k = 1}^{K} {I}_{k} \qquad [ Equation 1 ]$$

$$s . t . {x}_{k}^{m} ∈ \{ 0 , 1 \} , ∀ k , m ,$$

$${\sum }_{k = 1}^{K} {x}_{k}^{m} = 1 , ∀ m ,$$

$${( {\sum }_{k = 1}^{K} {I}_{k} )}^{2} / K {\sum }_{k = 1}^{K} {{I}_{k}}^{2} \geq {J}_{0}$$

In Equation 1 above, Iₖ may denote a throughput of a kth terminal, xₖ^{m} may denote a variable indicating a state in which the kth terminal is allocated to an mth RB (e.g., 0 indicates an unscheduled state, and 1 indicates a scheduled state), and J₀ may denote a set fairness index (e.g., Jain fairness index).

In Equation 1, a fairness index for the plurality of terminals may be

$${( {\sum }_{k = 1}^{K} {I}_{k} )}^{2} / K {\sum }_{k = 1}^{K} {{I}_{k}}^{2} ,$$

and a fairness condition for the plurality of terminals may indicate that the fairness index

$${( {\sum }_{k = 1}^{K} {I}_{k} )}^{2} / K {\sum }_{k = 1}^{K} {{I}_{k}}^{2}$$

becomes greater than or equal to the set fairness index J₀.

For example, according to a condition

$${\sum }_{k = 1}^{K} {x}_{k}^{m} = 1 , ∀ m$$

of Equation 1, there may be only one terminal to be allocated to each RB. According to a condition

$${( {\sum }_{k = 1}^{K} {I}_{k} )}^{2} / K {\sum }_{k = 1}^{K} {{I}_{k}}^{2} \geq {J}_{0}$$

of Equation 1, a value calculated based on the throughput Iₖ for each terminal may need to be greater than or equal to the set fairness index to satisfy the fairness condition.

For example, the training device 400-1 may train the neural network model 410-1 to output the variable xₖ^{m} indicative of the state of allocation of an RB to each terminal to satisfy the conditions of Equation 1. For example, training the neural network model 410-1 to output the schedule xₖ^{m} that satisfies Equation 1 may represent training the neural network model 410-1 to output a schedule by which the sum throughput for the plurality of terminals is maximized and the fairness index for the plurality of terminals satisfies the set fairness condition. For example, the schedule may indicate a state where the RBs are allocated respectively to all the plurality of terminals, i.e., xₖ^{m} (k=1, 2, . . . , K, and n=1, 2, . . . , N).

In an example, the training device 400-1 may calculate a ground truth (GT) schedule that maximizes the sum throughput for the plurality of terminals and satisfies the fairness index, based on the achievable rate. For example, the training device 400-1 may calculate the GT schedule that satisfies Equation 1 above.

In another example, a training device 400-2 may calculate the GT schedule based on Equation 2 below. Equation 2 may represent a condition modified or mitigated from of the condition for the binary variable xₖ^{m} of Equation 1 above. For example, the training device 400-2 may calculate the GT schedule using a method such as convex programming (CVX) or the like, according to the mitigated condition of Equation 2 below.

$${max}_{X} {\sum }_{k = 1}^{K} {I}_{k} \qquad [ Equation 2 ]$$

$$s . t . 0 \leq {x}_{k}^{m} \leq 1 , ∀ k , m ,$$

$${\sum }_{k = 1}^{K} {x}_{k}^{m} = 1 , ∀ m ,$$

$${\sum }_{k = 1}^{K} {I}_{k} \geq \sqrt{{J}_{0} K} \sqrt{{\sum }_{k = 1}^{K} {{I}_{k}}^{2}}$$

For example, the neural network model 410-1 may include a deep neural network (DNN) structure and an activation function. For example, the training device 400-1 may train the neural network model 410-1 using a loss 440 calculated using a loss function.

For example, the training device 400-1 may output a schedule 430 by inputting the achievable rate into the neural network model 410-1. For example, the training device 400-1 may calculate the loss 440 using the GT schedule and the schedule 430, based on the loss function. For example, the training device 400-1 may calculate the loss 440 with a smaller magnitude as a difference between the GT schedule and the schedule 430 is smaller. To calculate the loss 440, various known methods may be applied.

For example, the training device 400-1 may train the neural network model 410-1 such that the loss 440 is minimized. For example, the loss 440 calculated based on the loss function may be a mean squared error (MSE) between the schedule 430 output from the neural network model 410-1 and the calculated GT schedule.

The training device 400-1 of FIG. 4 may train the neural network model 410-1 to output the schedule 430 that allocates the RBs to the plurality of terminals such that the sum throughput of the entire network is maximized and the fairness index for the plurality of terminals satisfies the set fairness condition.

FIG. 5 is a diagram illustrating an example operation performed by the training device 400-2 to train a neural network model 410-2 based on an unsupervised learning method according to various embodiments.

Referring to FIG. 5, according to various embodiments, the training device 400-2 may train the neural network model 410-2 based on an unsupervised learning method. For example, the neural network model 210 used by the electronic device 200 of FIG. 2 may be the neural network model 410-2 trained by the training device 400-2 shown in FIG. 5.

In an example, a processor 420 including processing circuitry (e.g., the processor 120 of FIG. 1) of the training device 400-2 may identify CQI indexes for a plurality of terminals. For example, the processor 420 of the training device 400-2 may calculate an achievable rate based on the CQI indexes. For example, operations performed by the training device 400-2 of FIG. 5 to identify the CQI indexes and calculate the achievable rate may be substantially the same as the operations performed by the electronic device 200 of FIG. 2 or the training device 400-1 of FIG. 4 to identify the CQI indexes and calculate the achievable rate.

For example, the CQI indexes collected by the training device 400-2 of FIG. 5 may be used to train the neural network model 410-2 and may thus be referred to as training CQI indexes. For example, the achievable rate calculated by the training device 400-2 may be used to train the neural network model 410-2 and may thus be referred to as a training achievable rate.

In an example, the training device 400-2 of FIG. 5 may train the neural network model 410-2 to output a schedule 430 by which a sum throughput for the plurality of terminals is maximized and a fairness index for the plurality of terminals satisfies a set fairness condition. For example, the training device 400-2 may train the neural network model 410-2 to output the schedule 430 that satisfies the conditions, or constraints, of Equation 1 above.

In an example, the training device 400-2 may output the schedule 430 by inputting the achievable rate into the neural network model 410-2. For example, the training device 400-2 may calculate a loss 440 based on the output schedule 430.

In an example, the neural network model 410-2 may include an activation function for outputting a schedule that allows an RB to be allocated to only one of the plurality of terminals. For example, the schedule output through the activation function of the neural network model 410-2 may allow a state in which an RB is allocated to each terminal to have one value of two values 0 and 1, as in the condition xₖ^{m}∈{0,1}, ∀k,m, of Equation 1 above.

For example, the training device 400-2 may calculate the loss 440 based on a loss function such as one expressed in Equation 3 below. For example, according to Equation 3, the training device 400-2 may calculate a loss based on the loss function that is set such that the loss and the magnitude of the sum throughput according to the schedule 430 have a negative correlation and, when the fairness condition is not satisfied, the loss and the fairness index according to the schedule 430 have a negative correlation.

$$Loss ( X ) = - ( {\sum }_{k = 1}^{K} {I}_{k} - {F}_{1} \cdot max ( {F}_{2} - {( {\sum }_{k = 1}^{K} {I}_{k} )}^{2} / K {\sum }_{k = 1}^{K} {{I}_{k}}^{2} , 0 ) ) \qquad [ Equation 3 ]$$

In Equation 3 above, F₁ has a different value range of fairness (e.g.,

$${( {\sum }_{k = 1}^{K} {I}_{k} )}^{2} / K {\sum }_{k = 1}^{K} {{I}_{k}}^{2}$$

in Equation 3) from Iₖ, and thus F₂, a hyperparameter for normalization, may denote a hyperparameter corresponding to J₀ in Equation 1 above.

In Equation 3, the higher the sum of Iₖ, the smaller the magnitude of the loss, and thus the sum throughput Iₖ and the loss may have a negative correlation.

In Equation 3, if the fairness condition is not satisfied, e.g., if the magnitude of the fairness index

$${( {\sum }_{k = 1}^{K} {I}_{k} )}^{2} / K {\sum }_{k = 1}^{K} {{I}_{k}}^{2}$$

is smaller than the set fairness index J₀, then

$${F}_{2} - {( {\sum }_{k = 1}^{K} {I}_{k} )}^{2} / K {\sum }_{k = 1}^{K} {{I}_{k}}^{2} .$$

may be

$$max ( {F}_{2} - {( {\sum }_{k = 1}^{K} {I}_{k} )}^{2} / K {\sum }_{k = 1}^{K} {{I}_{k}}^{2} , 0 )$$

As the fairness index

$${( {\sum }_{k = 1}^{K} {I}_{k} )}^{2} / K {\sum }_{k = 1}^{K} {{I}_{k}}^{2}$$

increases, the magnitude of the loss may decrease, and the fairness index

$${( {\sum }_{k = 1}^{K} {I}_{k} )}^{2} / K {\sum }_{k = 1}^{K} {{I}_{k}}^{2}$$

and the loss may have a negative correlation.

In Equation 3, if the fairness condition is satisfied, e.g., if the magnitude of the fairness index

$${( {\sum }_{k = 1}^{K} {I}_{k} )}^{2} / K {\sum }_{k = 1}^{K} {{I}_{k}}^{2}$$

is less than the set fairness index J₀, then

$$max ( {F}_{2} - {( {\sum }_{k = 1}^{K} {I}_{k} )}^{2} / K {\sum }_{k = 1}^{K} {{I}_{k}}^{2} , 0 )$$

may be zero (0).

In an example, the training device 400-2 may train the neural network model 410-2 using the loss 440 calculated according to Equation 3 above. For example, the training device 400-2 may train the neural network model 410-2 to minimize the loss 440. For example, training the neural network model 410-2 to minimize the loss 440 calculated according to Equation 3 may represent training the neural network model 410-2 to maximize the sum throughput of the entire network and satisfy the set fairness condition.

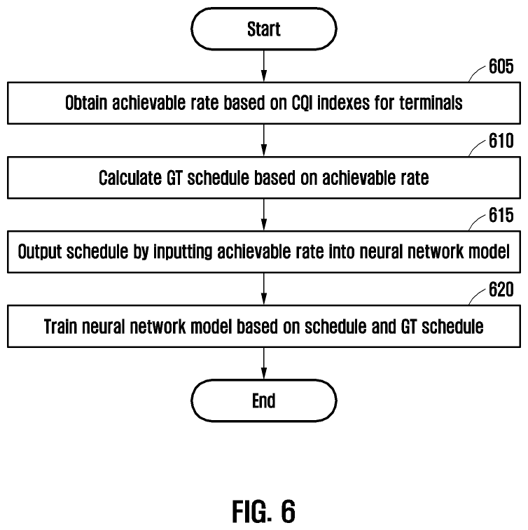

FIG. 6 is a flowchart illustrating an example supervised learning-based neural network model training method performed by a training device (e.g., the training device 400-1 of FIG. 4) to train a neural network model (e.g., the neural network model 410-1 of FIG. 4) based on supervised learning according to various embodiments.

Referring to FIG. 6, according to various embodiments, at operation 605, the training device 400-1 may obtain an achievable rate based on CQI indexes for a plurality of terminals. For example, the training device 400-1 may calculate the achievable rate for each terminal and RB based on a spectral efficiency based on the CQI indexes and an MCS.

For example, the CQI indexes and the achievable rate are training data for training the neural network model 410-1, which may also be referred to as training CQI indexes and a training achievable rate, respectively.

In an example, at operation 610, the training device 400-1 may calculate a GT schedule based on the achievable rate. For example, the training device 400-1 may calculate a GT schedule that satisfies set constraints.

For example, the set constraints may be calculating the GT schedule such that a sum throughput for the plurality of terminals is maximized and a fairness index for the plurality of terminals is greater than or equal to a set fairness index, as expressed in Equation 1 above. In Equation 1, a variable indicating a scheduling state of an RB for each terminal may be either 0 or 1, and each RB may be allocated to only one terminal.

For example, the training device 400-1 may calculate the GT schedule based on constraints with a mitigated condition for the variable indicating the scheduling state of an RB for each terminal, as expressed in Equation 2 above.

In an example, at operation 615, the training device 400-1 may output a schedule (e.g., the schedule 430 of FIG. 4) by inputting the achievable rate into the neural network model 410-1. For example, at operation 620, the training device 400-1 may train the neural network model 410-1 based on the schedule and the GT schedule.

For example, the training device 400-1 may calculate a loss based on the schedule and the GT schedule and train the neural network model 410-1 to minimize the loss. For example, the loss may be an MSE between the schedule and the GT schedule.

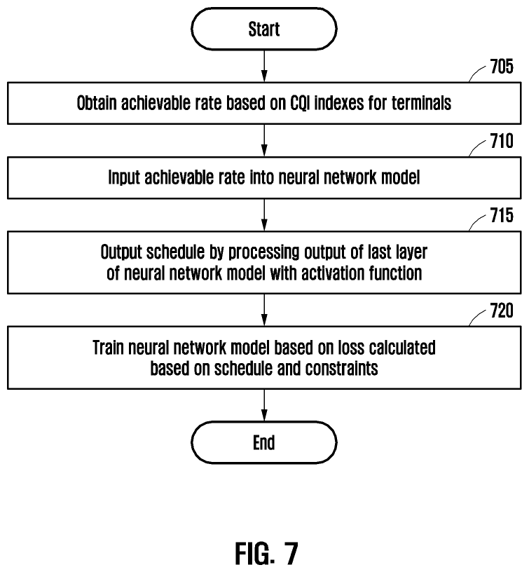

FIG. 7 is a flowchart illustrating an example unsupervised learning-based neural network model training method performed by a training device (e.g., the training device 400-2 of FIG. 5) to train a neural network model (e.g., the neural network model 410-2 of FIG. 5) based on unsupervised learning according to various embodiments.

Referring to FIG. 7, according to various embodiments, at operation 705, the training device 400-2 may obtain an achievable rate based on CQI indexes for a plurality of terminals. For example, operation 605 described above with reference to FIG. 6 may apply substantially the same to operation 705.

For example, the training device 400-2 may input the achievable rate into the neural network model 410-2 at operation 710, and may process an output of a last layer of the neural network model 410-2 with an activation function to output a schedule (e.g., the schedule 430 of FIG. 5) at operation 715.

For example, the activation function may process a continuous output range of the last layer of the neural network model 410-2 such that the schedule has one of two values, as in the condition (xₖ^{m}∈{0,1}, ∀k,m,) for a variable indicating a state in which an RB is allocated to each terminal in Equation 1 above.

For example, at operation 720, the training device 400-2 may train the neural network model 410-2 based on a loss calculated according to the schedule 430 and constraints. For example, in a case where the constraints are to maximize a sum throughput of the entire network and to satisfy a set fairness condition by a fairness index for the plurality of terminals, the training device 400-2 may calculate the loss based on a loss function for the sum throughput and the fairness condition, as expressed in Equation 3 above.

For example, the training device 400-2 may train the neural network model 410-2 based on the loss function set according to the constraints to allow the schedule 430 output from the neural network model 410-2 to maximize the sum throughput for the plurality of terminals and satisfy the fairness condition.

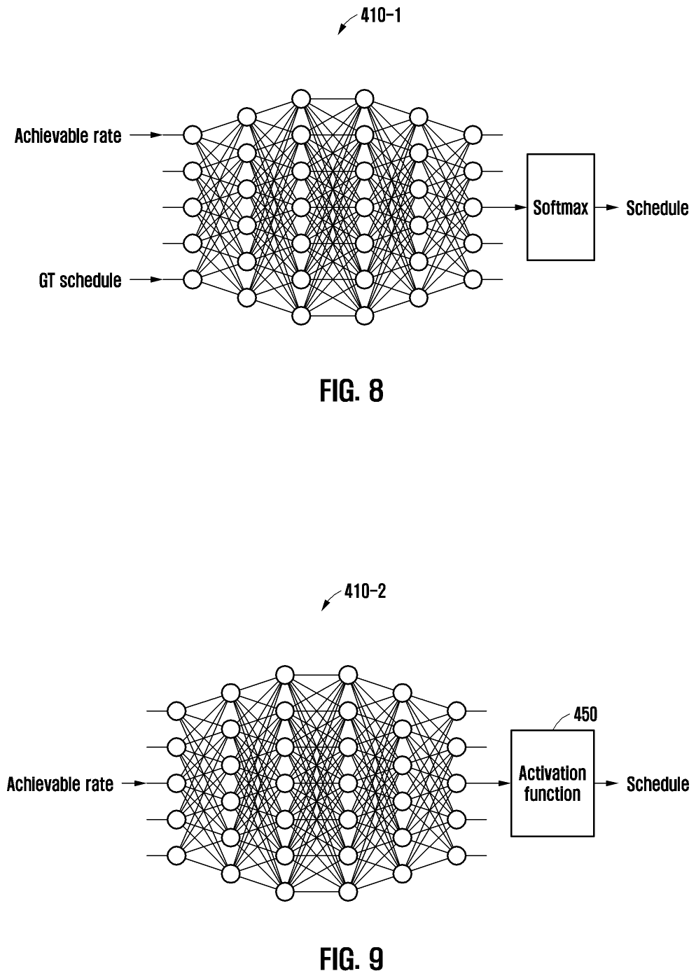

FIG. 8 is a diagram illustrating an example network structure of a neural network model (e.g., the neural network model 410-1 of FIG. 4) trained based on supervised learning according to various embodiments.

Referring to FIG. 8, the neural network model 410-1 may include a DNN structure including a plurality of layers and an activation function (e.g., Softmax in FIG. 8). For the neural network model 410-1 having the network structure shown in FIG. 8, a training device (e.g., the training device 400-1 of FIG. 4) may train the neural network model 410-1 based on a supervised learning method.

For example, the training device 400-1 may calculate a GT schedule based on an achievable rate according to Equation 1 or Equation 2 above. The training device 400-1 may train the neural network model 410-1 using a loss that is calculated based on a schedule (e.g., the schedule 430 of FIG. 4) output by inputting the achievable rate into the neural network model 410-1 and on the GT schedule.

FIG. 9 is a diagram illustrating an example network structure of a neural network model (e.g., the neural network model 410-2 of FIG. 5) trained based on unsupervised learning according to various embodiments.

Referring to FIG. 9, the neural network model 410-2 may include a DNN structure including a plurality of layers and an activation function 450 (e.g., one shown in FIG. 9). For the neural network model 410-2 having the network structure shown in FIG. 9, a training device (e.g., the training device 400-2 of FIG. 5) may train the neural network model 410-2 based on an unsupervised learning method.

For example, using the activation function 450, the training device 400-2 may output, from the neural network model 410-2, a schedule (e.g., the schedule 430 of FIG. 5) in which a variable indicating a state in which an RB is allocated to each terminal has one of two values, e.g., 0 or 1.

The training device 400-2 may calculate a loss (e.g., the loss 440 of FIG. 5) based on a loss function based on set constraints. The loss function may be set based on the constraints. For example, as expressed in Equation 3 above, the loss function may be set such that the loss 440 negatively correlates with a sum throughput of the entire network according to the output schedule 430.

For example, as expressed in Equation 3 above, the loss function may be set such that, when a fairness index according to the schedule 430 is less than or equal to a set fairness index, the fairness index and the loss 440 are negatively correlated. For example, a case where the fairness index according to the schedule 430 is less than or equal to the set fairness index may be construed that the set fairness condition is not satisfied.

For example, the neural network model 410-2 may be trained to calculate the loss 440 according to the loss function based on the set constraints and minimize the loss 440, and the neural network model 410-2 may thereby be trained to output the schedule 430 that satisfies the set constraints.

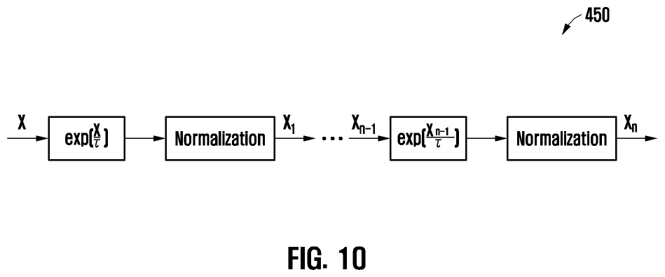

FIG. 10 is a diagram illustrating an example activation function 450 of a neural network model (e.g., the neural network model 410-2 of FIGS. 5 and 9) trained based on unsupervised learning according to various embodiments.

In FIG. 10, X may denote any information of xₖ^{m}. For example, X may indicate an output of the last layer of the neural network model 410-2 of FIG. 9.

Referring to FIG. 10, according to various embodiments, the activation function 450 may refer to a function that processes the output X of the last layer of the neural network model 410-2 using Equation 4 below and normalization n times.

$$exp ( \frac{X}{τ} ) \qquad [ Equation 4 ]$$

In Equation 4 above, τ may denote a temperature parameter that sets a slope based on an input of an exponential function.

For example, the output X of the last layer of the neural network model 410-1 may be processed according to the activation function 450 such that each of xₖ^{m} and ∀m in a schedule Xₙ to be output may have one of two values, e.g., 0 or 1.

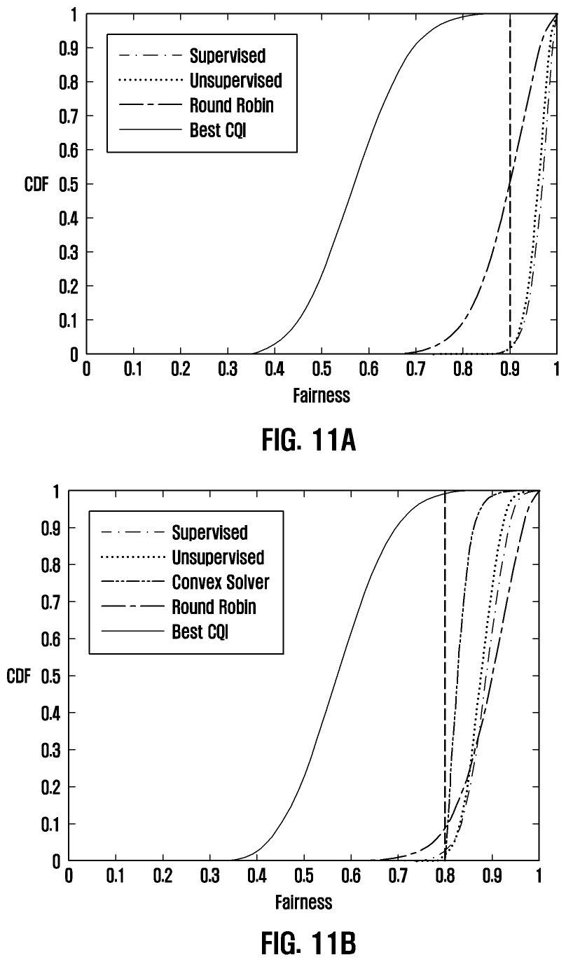

FIGS. 11A and 11B are graphs illustrating performance of an electronic device (e.g., the electronic device 200 of FIG. 2) using a trained neural network model (e.g., the neural network model 410-1 of FIG. 4 and the neural network model 410-2 of FIG. 5) according to various embodiments.

FIG. 11A is a graph illustrating the performance of the neural network model 410-1 trained based on a supervised learning method when J₀ is 0.9 and the performance of the neural network model 410-2 trained based on an unsupervised learning method when J₀ is 0.9.

FIG. 11B is a graph illustrating the performance of the neural network model 410-1 trained based on a supervised learning method when J₀ is 0.8 and the performance of the neural network model 410-2 trained based on an unsupervised learning method when J₀ is 0.8.

For example, a cumulative distribution function (CDF) in FIGS. 11A and 11A is an example result in response to J₀ with 25 RBs, 4 terminals, and 100,000 samples.

For example, Table 1 below shows parameters of the neural network model 410-1 trained based on the supervised learning method in FIGS. 11A and 11B, and Table 2 below shows parameters of the neural network model 410-2 trained based on the unsupervised learning method in FIGS. 11A and 11B.

TABLE 1

| Parameter | Setting |
|---|---|
| Optimizer | Adam |
| Hidden layer activation | Elu |
| Learning rate | 0.0001 |
| Loss function | Categorical cross entropy |
| # of training data | 100000 |
| # of test data | 10000 |

TABLE 2

| Parameter | Setting |
|---|---|
| Optimizer | Adam |
| Hidden layer activation | Relu |
| Learning rate | 0.0001 |
| Temperature | 0.1 |
| # of training data | 100000 |
| # of test data | 10000 |

Table 3 and Table 4 below show the performance of the neural network model 410-1 trained based on the supervised learning method and the performance of the neural network model 410-2 trained based on the unsupervised learning method, in FIG. 11A and FIG. 11B, respectively.

TABLE 3

| | Supervised | Unsupervised | | |
|---|---|---|---|---|
| | learning | learning | RR | Best-CQI |
| P(J ≥ J₀) | 0.9828 | 0.9829 | 0.4949 | 0.0001 |
| Sum throughput | 16.6657 | 16.8955 | 10.5555 | 19.3680 |
| (Mbps) | | | | |

TABLE 4

| | Supervised | Unsupervised | | |
|---|---|---|---|---|
| | learning | learning | RR | Best-CQI |
| P(J ≥ J₀) | 0.9711 | 0.98066 | 0.4949 | 0.0001 |
| Sum throughput | 17.8728 | 17.9828 | 10.5555 | 19.3680 |
| (Mbps) | | | | |

Referring to FIG. 11A and FIG. 11B, it may be verified that, as a probability that J₀ is satisfied (i.e., P(J≥J₀) in Tables 3 and 4) increases, e.g., when RBs are allocated to a plurality of terminals according to each method, the probability that a fairness index for the plurality of terminals satisfies a fairness condition increases, a sum throughput (shown in Tables 3 and 4) decreases according to a typical method (e.g., RR, best-CQI, and convex solver in FIGS. 11A and 11B and Tables 3 and 4). Referring to Table 3 and Table 4, some typical methods (RR and best-CQI) may not guarantee fairness, as values in P(J≥J₀) are 0.4949 and 0.0001, respectively.

Referring to FIGS. 11A and 11B, and Tables 3 and 4, it may be verified that the neural network model (e.g., 410-1 and 420-2) trained according to various embodiments (e.g., supervised learning and unsupervised learning in FIGS. 11A and 11B, and Tables 3 and 4) may increase the sum throughput while ensuring the given fairness condition (e.g., J₀).

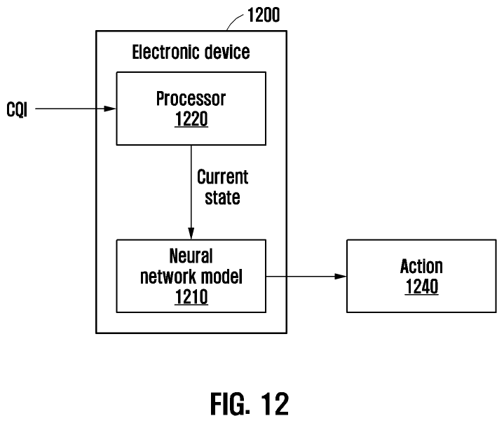

FIG. 12 is a diagram illustrating an example operation performed by an electronic device 1200 to output an action according to various embodiments.

Referring to FIG. 12, according to various embodiments, a processor 1220 including processing circuitry (e.g., the processor 120 of FIG. 1) of the electronic device 1200 (e.g., the electronic device 101 of FIG. 1) may identify CQI indexes for a plurality of terminals.

In an example, the electronic device 1200 may calculate a current state based on the CQI indexes. For example, the current state may include an average throughput for each of the plurality of terminals, a throughput, and an average fairness index for the plurality of terminals.

For example, the electronic device 1200 may calculate the throughput in substantially the same way as the electronic device 200 of FIG. 2 calculates an achievable rate.

For example, the processor 1220 of the electronic device 1200 may calculate the average throughput, Tₖ(n), as expressed in Equation 5 below. For example, the average throughput Tₖ(n) may refer to an average throughput of a kth user at an nth time index.

$${T}_{k} ( n ) = ( 1 - \frac{1}{{t}_{c}} ) {T}_{k} ( n - 1 ) + \frac{1}{{t}_{c}} {I}_{k} ( n ) \qquad [ Equation 5 ]$$

In Equation 5 above, Iₖ(n) may denote a throughput of the kth user at the nth time index, and t_{c} may denote a window time size of the average throughput Tₖ(n).

For example, the electronic device 1200 may calculate the average fairness index using the average throughput Tₖ(n) for each terminal. For example, the average fairness index for the plurality of terminals may be calculated as

$${( {\sum }_{k = 1}^{K} {T}_{k} ( n ) )}^{2} / K {\sum }_{k = 1}^{K} {{T}_{k} ( n )}^{2} .$$

In an example, the electronic device 1200 may output an action 1240 by inputting the current state into a neural network model 1210. For example, the action 1240 may represent a schedule for allocating RBs to the plurality of terminals for a set period of time.

For example, the neural network model 1210 may be trained according to a deep Q-network (DQN) learning method. For example, the neural network model 1210 may be trained using training data including a current state, an action, a reward, and a subsequent state. For example, the neural network model 1210 may be trained to output an action that maximizes a reward in response to the training data that is input. For example, the neural network model 1210 may calculate a Q-value based on the input current state and output the action 1240 associated with a maximum Q-value among calculated Q-values.

For example, the reward may be determined based on a reward function based on constraints set for allocating RBs to a plurality of terminals.

For example, the constraints may require i) the sum of average throughputs of the plurality of terminals be maximized, ii) the throughput for the plurality of terminals be greater than or equal to a set quality of service (QOS), iii) the number of RBs to be allocated to each of the plurality of terminals be less than or equal to a set number of RBs, and iv) the average fairness index for the plurality of terminals be greater than or equal to a set fairness index.

For example, the reward function may be determined based on i) the sum of the average throughputs of the plurality of terminals, ii) the fairness index for the plurality of terminals, and iii) the set QoS and the set maximum number of RBs.

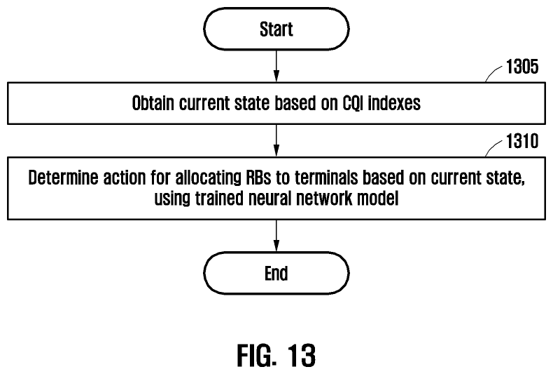

FIG. 13 is a flowchart illustrating an example scheduling method performed by an electronic device (e.g., the electronic device 1200 of FIG. 12) according to various embodiments.

Referring to FIG. 13, according to various embodiments, at operation 1305, the electronic device 1200 may obtain a current state based on CQI indexes. For example, the current state may include an average throughput, a throughput, and an average fairness index for a plurality of terminals.

In an example, at operation 1310, the electronic device 1200 may use a trained neural network model (e.g., the neural network model 1210 of FIG. 12) to determine an action for allocating RBs to the plurality of terminals based on the current state.

For example, the neural network model 1210 may be trained to output the action that satisfies set constraints. For example, the neural network model 1210 may be trained using training data (s, a, r, s′) that includes a current state(s), an action (a), a reward (r), and a subsequent state (s′), according to a DQN learning method.

For example, the neural network model 1210 may be trained to maximize the reward. For example, the reward may be determined by a reward function that is set to have a high value when the constraints are satisfied.

For example, the constraints may be to allocate the RBs to the plurality of terminals such that a sum of average throughputs of the plurality of terminals is maximized and an average fairness index for the plurality of terminals is greater than or equal to a set fairness index. For example, the constraints may be to allocate the RBs such that the number of RBs to be allocated to each terminal is less than or equal to a maximum number of RBs set for each terminal and a throughput of each terminal satisfies a set minimum QoS.

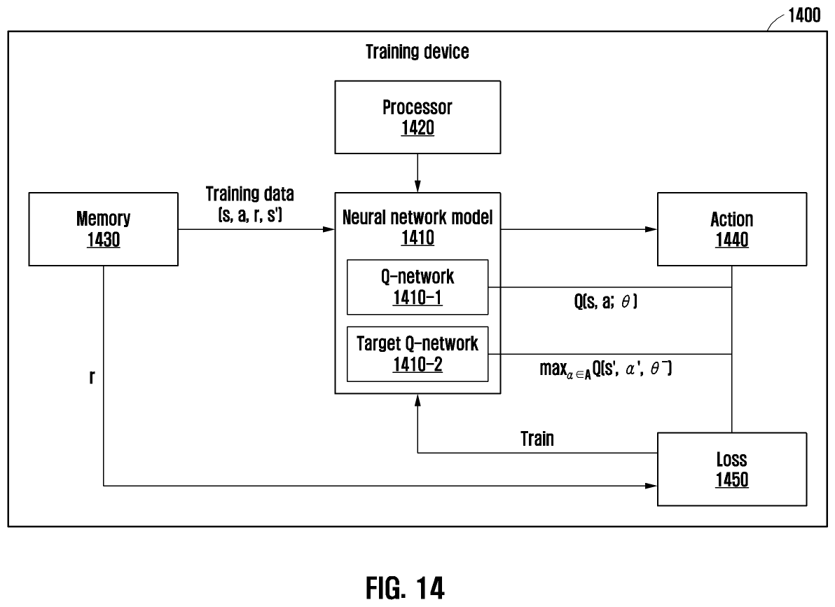

FIG. 14 is a diagram illustrating an example operation performed by a training device 1400 (e.g., the electronic device 101 of FIG. 1) to train a neural network model 1410 according to various embodiments.

Referring to FIG. 14, according to various embodiments, the training device 1400 may train the neural network model 1410 using training data. For example, the training device 1400 may train the neural network model 1410 to output an action 1440 that satisfies Equation 6 below.

$${max}_{x} {\sum }_{k = 1}^{K} {T}_{k} ( n ) \qquad [ Equation 6 ]$$

$$s \text{?} {x}_{k}^{m} ( n ) ∈ \{ 0 , 1 \} , ∀ k , m ,$$

$${\sum }_{k = 1}^{K} {x}_{k}^{m} ( n ) = 1 , ∀ m ,$$

$${\sum }_{m = 1}^{N} {x}_{k}^{m} ( n ) \leq B , ∀ k ,$$

$${I}_{k} ( n ) \geq {r}_{min} , ∀ k$$

$${( {\sum }_{k = 1}^{K} {T}_{k} ( n ) )}^{2} / K {\sum }_{k = 1}^{K} {{T}_{k} ( n )}^{2} \geq {J}_{0}$$

$$\text{?} \text{indicates text missing or illegible when filed}$$

In Equation 6 above, Tₖ(n) may denote an average throughput of a kth terminal at an nth time index, xₖ^{m}(n) may denote a variable indicating a state in which an mth RB is allocated to the kth terminal at the nth time index (e.g., 0 indicates a state where no RB is allocated, and 1 indicates a state where an RB is allocated), rₘᵢₙ may denote a set QoS condition, J₀ may denote a set fairness index (e.g., Jain fairness index), Iₖ(n) may denote a throughput of the kth terminal at the nth time index, and B may denote a maximum number of RBs that may be allocated to one terminal.

For example, the training device 1400 may train the neural network model 1410 to output the action 1440 that satisfies the constraints of Equation 6 above. The constraints of Equation 6 may require that i) a sum of average throughputs of a plurality of terminals be maximized, ii) each RB be allocated to only one terminal, iii) the maximum number of RBs to be allocated to one terminal be less than or equal to B, iv) a throughput Iₖ(n) of each terminal satisfy the set QoS condition, and v) the average fairness index be greater than or equal to the set fairness index.

For example, the throughput Iₖ(n) of the kth terminal at the nth time index in Equation 6 above may be calculated as expressed in Equation 7 below.

$${I}_{k} ( n ) = {\sum }_{m = 1}^{M} {r}_{k}^{m} ( n ) {x}_{k}^{m} ( n ) \qquad [ Equation 7 ]$$

In Equation 7 above, rₖ^{m}(n) may denote an achievable rate predicted when an mth RB is allocated to the kth terminal at the nth time index. For example, the training device 1400 may calculate the achievable rate rₖ^{m}(n) in substantially the same way as the electronic device 200 of FIG. 2 and the training devices 400-1 and 400-2 of FIGS. 4 and 5 calculate the achievable rate using the CQI indexes. For example, a processor 1420 (e.g., the processor 120 of FIG. 1) of the training device 1400 may train the neural network model 1410 using the training data stored in a memory 1430. For example, the training data (s, a, r, s′) may refer to a current state, an action, a reward, and a subsequent state, respectively.

In an example, the neural network model 1410 may be trained according to a DQN learning method. For example, the training data (s, a, r, s′) may be collected based on a fact that a state in a given environment is changed from the current state(s) to the subsequent state (s′) according to an action of an agent in the given environment, and the reward (r) is based on the action.

For example, the action of the agent in the environment may be performed over a plurality of episodes, and the training data may be stored in the memory 1430. For example, the memory 1430 may be referred to as a replay memory. For example, the agent may perform the action in a e-greedy manner at each time step.

For example, the training data may be collected by performing the action of the agent in the environment and storing the reward from the action and the subsequent state in the memory 1430. An operation of the agent according to the action (a) in the current state(s) in the environment may correspond to a finite Markov decision process (MDP) because it affects the entire system.

For example, the training device 1400 may perform a mini-batch update by sampling the training data stored in the memory 1430 in various ways, such as, for example, random sampling, prioritized experience replay (PER)-based sampling, or the like.

For example, the training device 1400 may train the neural network model 1410 to estimate a function that determines a Q-value, according to the DQN learning method. For example, the training device 1400 may use the current state as an input to extract the Q-value as an output. For example, the neural network model 1410 may include a plurality of neural networks (NNs) to determine the Q-value.

For example, for the action (a) performed by the agent, an immediate reward and a future reward may be received from the environment. For example, the immediate reward may refer to a reward that immediately occurs in response to the action (a) performed by the agent, and the future reward may refer to a reward for a future environment that occurs due to the action (a).

For example, a goal of the agent may be to maximize the reward, i.e., to obtain maximum immediate and future rewards, and thus the Q-value, or Q (Sₜ, Aₜ), may be updated for the goal.

$$[ Equation 8 ]$$

$$Q ( {S}_{t} , {A}_{t} ) ← Q ( {S}_{t} , {A}_{t} ) + α [ {R}_{t + 1} + γ \text{?} Q ( {S}_{t + 1} , \text{?} , {θ}^{-} ) - Q ( {S}_{t} , {A}_{t} , θ ) ]$$

$$\text{?} \text{indicates text missing or illegible when filed}$$

Equation 8 above may be to update a Q-value Q (Sₜ, Aₜ) for an action Aₜ in a current state Sₜ, in which α may denote a learning rate of a Q-value greater than or equal to zero (0) to less than or equal to 1, γ may denote a discount factor for the future reward, γ_{α′∈A}^{max}Q(Sₜ₊₁,α′,θ⁻) may denote a maximum value of the future reward, and Rₜ₊₁ may denote the immediate reward.

For example, the neural network model 1410 may perform the action in a selection process and an evaluation process using respective networks. For example, the neural network model 1410 may include a Q-network 1410-1 and a target Q-network 1410-2. In Equation 8 above, θ may denote a parameter of the Q-network 1410-1, and θ⁻ may denote a parameter of the target Q-network 1410-2. For example, the target Q-network 1410-2 may refer to a network that copies the parameter of the Q-network 1410-1 at certain steps.

In an example, the Q-network 1410-1 may refer to a network for outputting a Q-value and the target Q-network 1410-2 may refer to a network for evaluating an action. For example, the training device 1400 may input the current state and the action, or (s, a), of the training data into the Q-network 1410-1 to output the Q-value, or Q (s, a, θ). For example, the training device 1400 may input the subsequent state (s′) of the training data into the target Q-network 1410-2 to output max_{α∈A}Q(s′,α′, θ\hat{ }). For example, max_{α∈A}Q(s′, α′, θ ̆) may represent a maximum value of the future reward to update the Q-value in Equation 8 above. For example, max_{α∈A}Q(s′, α′, θ⁻) may indicate a value for evaluating the action.

For example, the Q-value that may be calculated using the Q-network 1410-1 and the target Q-network 1410-2 may be calculated as expressed in Equation 9 below.

$${y}^{DDQN} = {R}_{t} + γQ ( {s}_{t + 1} , {arg max}_{{a}_{t + 1}} {Q}_{t + 1} ( {s}_{t + 1} , {a}_{t + 1} , {θ}^{′} ) ; {θ}^{-} ) \qquad [ Equation 9 ]$$

In Equation 9 above, y^{DDQN} may denote a Q-value (e.g., Q (Sₜ, Aₜ) in Equation 8), and Rₜ may denote the immediate reward.

For example, the reward function may be set as expressed in Equation 10 below.

$${F}_{1} {\sum }_{k = 1}^{K} {T}_{k} ( n ) + {F}_{2} \vert {J}_{0} - \frac{{( {\sum }_{k = 1}^{K} {T}_{k} ( n ) )}^{2}}{K {\sum }_{k = 1}^{K} {{T}_{k} ( n )}^{2}} \vert + {F}_{3} \qquad [ Equation 10 ]$$

In Equation 10 above, F₁, F₂, and F₃ may denote hyperparameters. For example, F₁ may denote a variable for scaling the magnitude of a sum

$${\sum }_{k = 1}^{K} {T}_{k} ( n )$$

of average throughputs and a set average fairness index.

For example, F₂ may denote a variable for responding to a case where a fairness condition is satisfied when an average fairness index is greater than the set average fairness index.

For example, F₃ may denote a parameter corresponding to a QoS condition and a limit on the maximum number of RBs.

Table 5 below is a table indicating the ranges of hyperparameters F₁, F₂, and F₃ of Equation 10, according to an embodiment.

TABLE 5

| | |
|---|---|
| When requirements are satisfied | When requirements are not satisfied |

F₁ (scaling parameter)

| | |
|---|---|
| F₂ < 0 | F₂ > 0 |
| F₃ < 0 | F₃ = 0 |

In Table 5 above, a requirement for determining the range of F₂ may represent a condition

$${( {\sum }_{k = 1}^{K} {T}_{k} ( n ) )}^{2} / K {\sum }_{k = 1}^{K} {{T}_{k} ( n )}^{2} \geq {J}_{0} \text{?}$$

$$\text{?} \text{indicates text missing or illegible when filed}$$

in Equation 6 above.

In Table 5 above, a requirement for determining the range of F₃ may represent a condition

$${\sum }_{m = 1}^{N} \text{?} ( n ) \leq B , ∀ k ,$$

$$\text{?} \text{indicates text missing or illegible when filed}$$

and a condition Iₖ(n)≥rₘᵢₙ, ∀k of Equation 6.

According to Equation 10 above, the reward function may be determined based on the sum

$${\sum }_{k = 1}^{K} {T}_{k} ( n )$$

of the average throughputs, the average fairness index

$$\frac{{( {\sum }_{k = 1}^{K} {T}_{k} ( n ) )}^{2}}{K {\sum }_{k = 1}^{K} {{T}_{k} ( n )}^{2}} ,$$

the set maximum number of RBs, and the set QoS (e.g., the hyperparameter F₃).

The reward determined according to the reward function of Equation 10 above may be determined to be a high value when the constraints of Equation 10 are satisfied, and may be determined to be a low value when the constraints of Equation 10 are not satisfied. For example, of the training data (s, a, r, s′), the reward in the case where a result from the action (a) performed in the current state(s) satisfies the constraints according to Equation 6 above may be assigned a value greater than a value of a reward in the case where the constraints are not satisfied.

The reward function of Equation 10 above may be set according to the constraints of Equation 6 above, and may be set differently from Equation 10 according to the set constraints.

For example, when allocating RBs to a plurality of terminals, various variables such as CQI, type of service, QoS, buffer status, priority, retransmission, scheduling period, and the like may be considered. For example, when the priority is considered, as opposed to the constraints of Equation 6 above, the reward function may be set such that a higher reward is assigned when allocating the RBs based on priority.

For example, the training device 1400 may calculate a loss, as expressed in Equation 11 below.

$${( {r}_{t + 1} + γ {max}_{{a}_{t + 1}} {Q}_{t + 1} ( {s}_{t + 1} , {a}_{t + 1} , {θ}^{-} ) - Q ( {s}_{t} , {a}_{t} , θ ) )}^{2} \qquad [ Equation 11 ]$$

For example, the training device 1400 may train the neural network model 1410 to minimize the loss according to Equation 11. Training the neural network model 1410 to minimize the loss according to Equation 11 may represent training the neural network model 1410 to maximize the reward according to Equation 10.

For example, in Equation 11, rₜ₊₁ may denote a reward (r) of training data,

$$\text{?} {Q}_{t + 1} ( \text{?} , \text{?} , {θ}^{-} )$$

$$\text{?} \text{indicates text missing or illegible when filed}$$

may denote data output from the target Q-network 1410-2, and Q (Sₜ, α, θ) may denote data output from the Q-network 1410-1.

For example, the reward may be determined based on the reward function (e.g., Equation 8) set according to the constraints of Equation 6. In this example, the action 1440 output from the neural network model 1410 trained to maximize the reward may satisfy the constraints of Equation 6.

In an example, the training device 1400 may perform training to output the action 1440 that maximizes the reward. For example, the training device 1400 may train the neural network model 1410 to output the action 1440 by which a sum throughput for a plurality of terminals is maximized and an average fairness index of the plurality of terminals is greater than or equal to a set fairness index. For example, the action 1440 output from the trained neural network model 1410 may be to cause the number of RBs to be allocated to each of the plurality of terminals to be less than or equal to a set number of RBs, and the average fairness index for the plurality of terminals to be greater than or equal to the set fairness index.

In an example, the training device 1400 may sample the training data using PER. The PER may refer to a technique for sampling the training data stored in the memory 1430 according to priority, in a technique for randomly sampling the training data and performing a mini-batch update. For example, in a case where training is continued using only the training data that minimizes the loss of Equation 11, updates may be made continuously only when the loss is replayed, and thus there may be no opportunity to reiterate for an initially large loss, which may lead to insufficient learning of various experiences, causing over-fitting for a certain transition.

In an example, the training device 1400 may sample the training data according to Equation 12 below. For example, Equation 12 may represent a probability obtained by applying uniform random sampling and prioritized sampling techniques.

$$P ( i ) = \frac{{p}_{i}^{α}}{{\sum }_{k} {p}_{k}^{α}} \qquad [ Equation 12 ]$$

In Equation 12 above, P(i) may denote a sampling probability of an ith transition among k transitions, and α may denote a parameter determining whether to perform prioritization sampling. For example, in Equation 12, α being zero (0) may indicate uniform sampling, and α being 1 may indicate greedy-prioritization sampling.

In Equation 12, pᵢ may denote a parameter that is set to be proportional to the loss in Equation 11 through a proportional prioritization method, and may be set such that a probability for a visit of all transitions is not zero (0).

For example, prioritized replay according to Equation 12 may tend to result in biased information. In an example, the training device 1400 may compensate for a bias value using a weight according to Equation 13 below.

$${w}_{i} = {( \frac{1}{N} \cdot \frac{1}{P ( i )} )}^{β} \qquad [ Equation 13 ]$$

In Equation 13 above, wᵢ may denote an importance-sampling (IS) weight, and β may denote a parameter that adjusts the bias value. For example, β may be set to increase linearly with each training step and may be set to be equal to 1 at the last step of training.

For example, the training device 1400 may adjust the parameters α and β in Equation 12 and Equation 13 to adjust the size of a gradient of the loss, thereby increasing the stability and performance of the trained neural network model 1410.

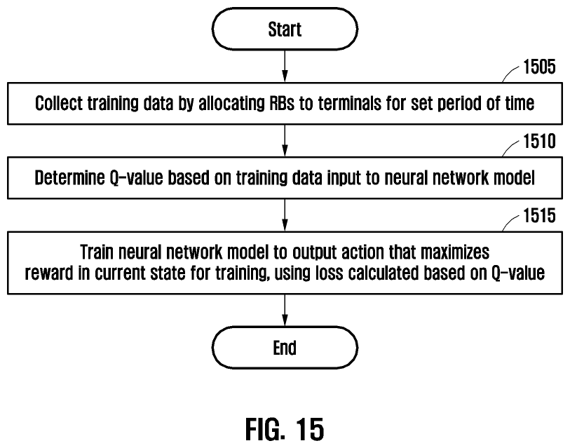

FIG. 15 is a flowchart illustrating an example neural network model training method performed by a training device (e.g., the training device 1400 of FIG. 14) to train a neural network model (e.g., the neural network model 1410 of FIG. 14) according to various embodiments.

Referring to FIG. 15, according to various embodiments, at operation 1505, the training device 1400 may allocate RBs to a plurality of terminals for a set period of time and collect training data. For example, the training data may be collected as an action of an agent in an environment is performed, and may include a current state, an action, a reward, and a subsequent state.

In an example, at operation 1510, the training device 1400 may determine a Q-value based on the training data input to the neural network model 1410. For example, the neural network model 1410 may include the Q-network 1410-1 and the target Q-network 1410-2.

In an example, at operation 1515, the training device 1400 may train the neural network model 1410 to output an action that maximizes a reward in a current state for training, using a loss calculated based on the Q-value.

For example, the training device 1400 may calculate the loss according to Equation 11, using an output of the Q-network 1410-1, an output of the target Q-network 1410-2, and the reward from the training data. The training device 1400 may train the neural network model 1410 to minimize the loss.

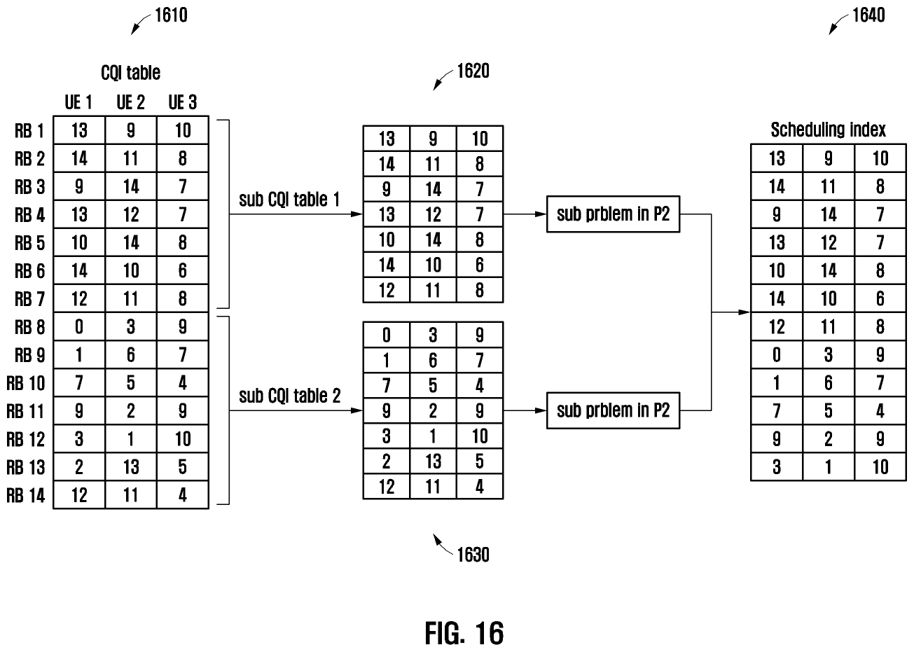

FIG. 16 is a diagram 1640 illustrating an example operation performed by an electronic device (e.g., the electronic device 1200 of FIG. 12) to divide a plurality of terminals or RBs into subgroups (e.g., sub-CQI tables 1620 and 1630) according to various embodiments.

For example, a space of states and actions may increase with the number of terminals to which RBs are to be allocated or the number of RBs. As the number of terminals or the number of RBs increases, the cost in terms of time and computation required to train a neural network model (e.g., the neural network model 1410 of FIG. 14) may increase.

Since the number of terminals and/or the number of RBs may vary depending on a communication situation, there may be a need for a method that reduces the cost of training the neural network model 1410 and utilizes the neural network model 1410 applicable in each case.

For example, a training device (e.g., the training device 1400 of FIG. 14) may divide a large-dimensional CQI table 1610 into a plurality of sub-CQI tables 1620 and 1630.

Although the sub-CQI tables 1620 and 1630 shown in FIG. 16 illustrate an example of dividing RBs, examples are not limited thereto. Sub-CQI tables may be generated by dividing a plurality of terminals, or sub-CQI tables may be generated by dividing a plurality of terminals and RBs.

For example, the training device 1400 may train a plurality of neural network models using the sub-CQI tables 1620 and 1630, respectively. For example, the training device 1400 may train neural network model 1 using the sub-CQI table 1620 and train neural network model 2 using the sub-CQI table 1630.

For example, using the plurality of trained neural network models, the electronic device 1200 may output an action for allocating RBs to a plurality of terminals. For example, the electronic device 1200 may identify CQI indexes for the plurality of terminals and divide the CQI table 1610 into the plurality of sub-CQI tables 1620 and 1630, as shown in FIG. 16. Each of the sub-CQI tables 1620 and 1630 may also be referred to as a subgroup.

For example, the electronic device 1200 may input the sub-CQI table 1620 into the trained neural network model 1 to output an action, and input the sub-CQI table 1630 into the trained neural network model 2 to output an action. The electronic device 1200 may combine the actions output from the trained neural network models 1 and 2 to output the action for allocating all the RBs to the plurality of terminals.

In another example different from the one shown in FIG. 16, the electronic device 1200 or the training device 1400 may divide a plurality of terminals in the CQI table 1610 to determine sub-CQI tables. For example, it may divide a CQI table associated with the plurality of terminals, e.g., UE 1 to UE 6, to determine a sub-CQI table associated with terminals (e.g., UE 1 to UE 3) and a sub-CQI table associated with terminals (e.g., UE 4 to UE 6).

For example, when generating the sub-CQI tables by dividing the plurality of terminals, the processor 1220 or 1420 of the electronic device 1200 or the training device 1400 may ensure that an RB is not allocated to the same terminal.

For example, the processor 1220 of the electronic device 1200 may output an action to ensure that an RB is not allocated to the same terminal. For example, the processor 1420 of the training device 1400 may train the neural network model 1410 to output an action ensuring that the RB is not allocated to the same terminal.

Although operations performed by the electronic device 1200 of FIG. 12 or the training device 1400 of FIG. 14 to divide the CQI table 1610 into the sub-CQI tables 1620 and 1630 and train a plurality of neural network models using the sub-CQI tables 1620 and 1630 or output an action using the plurality of neural network models are described with reference to

FIG. 16, examples are not limited thereto.

For example, substantially the same description of the operations performed by the electronic device 1200 or the training device 1400 of FIG. 16 may apply to the operations performed by the electronic device 200 of FIG. 2 or the training devices 400-1 and 400-2 of FIGS. 4 and 5.

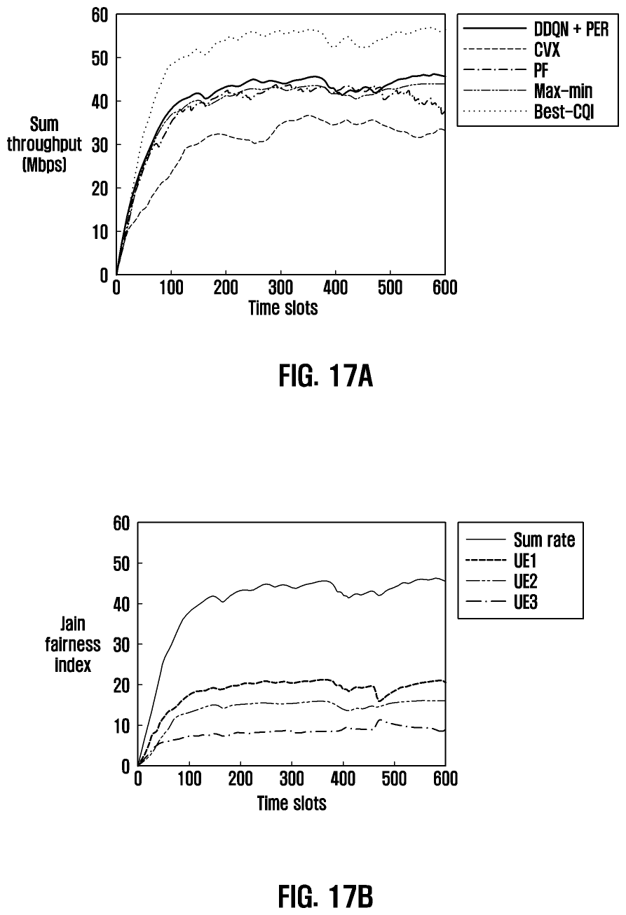

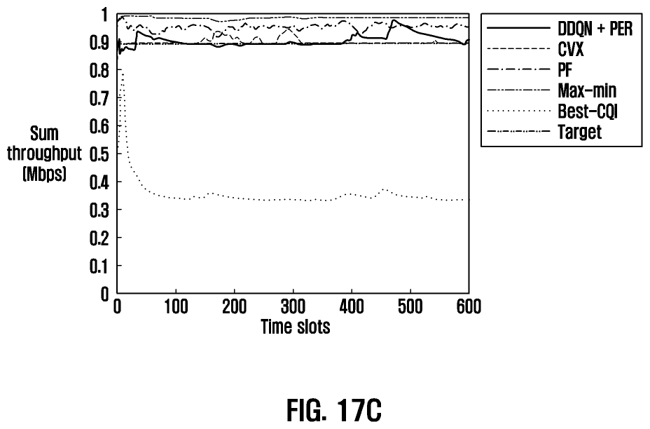

FIGS. 17A, 17B, and 17C are graphs illustrating the performance of a trained neural network model (e.g., the neural network model 1410 of FIG. 14) according to various embodiments.

A graph shown in FIG. 17A shows a sum throughput for a plurality of terminals, a graph shown in FIG. 17B shows a throughput for each terminal (or a UE throughput), and a graph shown in FIG. 17C shows a Jain fairness index.

For example, the neural network model 1410 may be trained based on parameters shown in Table 6 below.

TABLE 6

| Parameter | Setting |
|---|---|
| ε-greedy parameter | 0.9999 |
| εₘᵢₙ | 0.01 |
| Learning rate | 0.0001 |
| Hidden layer activation | Relu |
| Batch size | 256 |
| # of episodes | 2000 |

Referring to FIGS. 17A, 17B, and 17C, the neural network model 1410 trained according to various embodiments may exhibit improved performance compared to typical algorithms or methods for allocating RBs. Although a sum throughput obtained by a typical best-CQI method is higher than a sum throughput obtained by the trained neural network model 1410, it may not satisfy a fairness condition and a minimum QoS condition.

Referring to FIG. 17A, 17B, and 17C, it may be verified that the trained neural network model 1410 exhibits a fairness index higher than a target fairness, while having the sum throughput or per-user throughput that is similar to that obtained by a PF or max-min method.

Table 7 below shows an outage probability indicating unsatisfaction of the minimum QoS. Referring to Table 7, it may be verified that approximately 2.1% of actions (e.g., DDQN+PER) output by the electronic device 1200 using the neural network model 1410 do not satisfy the minimum QoS condition, which is a higher performance compared to other methods.

TABLE 7

| | DDQN + PER | CVX | PF | Best-CQI | Max-min |
|---|---|---|---|---|---|
| P(Iₖ(n) < rₘᵢₙ) | 2.1% | 1.3% | 7.8% | 98.0% | 99.6% |

According to various example embodiments, an electronic device (e.g., the electronic device 101 of FIG. 1) may include at least one processor comprising processing circuitry (e.g., the processor 120 of FIG. 1); and a memory (e.g., the memory 130 of FIG. 1) electrically connected to the processor and storing instructions executable by at least one processor. At least one processor, individually and/or collectively, may be configured execute the instructions and to: obtain an achievable rate predicted when resource blocks (RBs) are allocated to a plurality of terminals, based on channel quality information (CQI) indexes for the plurality of terminals; and output a schedule for allocating the RBs to the plurality of terminals by inputting the achievable rate into a trained neural network model (e.g., the neural network model 410-1 of FIG. 4 and the neural network model 410-2 of FIG. 5). The neural network model may be configured to be trained to: collect training CQI indexes for the plurality of terminals; obtain a training achievable rate predicted based on the RBs being allocated to the plurality of terminals based on the training CQI indexes; and output the schedule, using the training achievable rate input, such that a sum throughput for the plurality of terminals is maximized and a fairness index for the plurality of terminals satisfies a set fairness condition.

The neural network model may be trained to calculate a ground truth (GT) schedule that maximizes the sum throughput for the plurality of terminals and satisfies the fairness condition based on the achievable rate, and may be trained based on a supervised learning method, using the achievable rate and the GT schedule.

The neural network model may be trained based on an unsupervised learning method.

The neural network model may include an activation function configured to output the schedule that allows an RB to be allocated to only one of the plurality of terminals.

The neural network model may be trained based on a loss function set such that a magnitude of the sum throughput according to the schedule and a loss have a negative correlation, and in response to the fairness condition not being satisfied, the fairness index according to the schedule and the loss have a negative correlation.

According to various example embodiments, an electronic device (e.g., the electronic device 101 of FIG. 1) may include at least one processor comprising processing circuitry (e.g., the processor 120 in FIG. 1); and a memory (e.g., the memory 130 of FIG. 1) electrically connected to at least one processor and storing instructions executable by at least one processor. At least one processor, individually and/or collectively, may be configured to execute the instructions, and to: obtain, based on channel quality information (CQI) indexes for a plurality of terminals, a current state including an average throughput of each of the plurality of terminals, a throughput, and an average fairness index for the plurality of terminals; and determine an action for allocating resource blocks (RBs) to the plurality of terminals based on the current state, using a neural network model (e.g., the neural network model 1410 of FIG. 14) trained according to a deep-Q network (DQN) learning method. The neural network model may be configured to be trained to output the action that maximizes a reward in the current state, and the reward may be determined based on a reward function according to constraints set for allocating the RBs to the plurality of terminals.

The constraints may require that a sum of respective average throughputs of the plurality of terminals be maximized, the throughput for the plurality of terminals be greater than or equal to a set quality of service (QOS), the number of RBs to be allocated to each of the plurality of terminals be less than or equal to a set maximum number of RBs, and the average fairness index for the plurality of terminals be greater than or equal to a set fairness index.

The reward may be determined according to a reward function determined based on the sum of the average throughputs of the plurality of terminals, the average fairness index for the plurality of terminals, the set QoS, and the set maximum number of RBs.

At least one processor, individually and/or collectively, may be configured to: determine a plurality of subgroups by dividing at least one of the plurality of terminals or the RBs based on the number of the plurality of terminals or the number of the RBs; and output the action for each of the plurality of subgroups by inputting the current state of each of the plurality of subgroups into the neural network model.

The neural network model may be configured to be trained using a Q-network configured to output a Q-value based on the action and a target Q-network configured to evaluate the action.

According to various example embodiments, a scheduling method may include: obtaining, based on channel quality information (CQI) indexes for a plurality of terminals, a current state including an average throughput of each of the plurality of terminals, a throughput, and an average fairness index for the plurality of terminals; and determining an action for allocating resource blocks (RBs) to the plurality of terminals based on the current state, using a neural network model trained according to a deep-Q network (DQN) learning method. The neural network model may be configured to be trained to output the action that maximizes a reward in the current state, and the reward may be determined based on a reward function according to constraints set for allocating the RBs to the plurality of terminals.

The constraints may require that a sum of respective average throughputs of the plurality of terminals be maximized, the throughput for the plurality of terminals be greater than or equal to a set quality of service (QOS), the number of RBs to be allocated to each of the plurality of terminals be less than or equal to a set maximum number of RBs, and the average fairness index for the plurality of terminals be greater than or equal to a set fairness index.

The reward may be determined according to a reward function determined based on the sum of the average throughputs of the plurality of terminals, the average fairness index for the plurality of terminals, the set QoS, and the set maximum number of RBs.

The scheduling method may further include determining a plurality of subgroups by dividing at least one of the plurality of terminals or the RBs, based on the number of the plurality of terminals or the number of the RBs. The determining of the action may include outputting the action for each of the plurality of subgroups by inputting the current state of each of the plurality of subgroups into the neural network model.

The neural network model may be configured to be trained using a Q-network configured to output the action and a target network for evaluating the action, with a double deep-Q network (DDQN) model.

According to various example embodiments, a neural network model training method may include: allocating resource blocks (RBs) to a plurality of terminals for a set period of time and collecting training data including a current state, an action, a reward, and a subsequent state; determining a Q-value based on the training data input to a neural network model; and training the neural network model to output the action that maximizes the reward in the current state, using a loss calculated based on the Q-value. The reward may be determined based on a reward function according to set constraints for allocating the RBs to the plurality of terminals.

The constraints may require that a sum of respective average throughputs of the plurality of terminals be maximized, the throughput for the plurality of terminals be greater than or equal to a set quality of service (QOS), the number of RBs to be allocated to each of the plurality of terminals be less than or equal to a set maximum number of RBs, and the average fairness index for the plurality of terminals be greater than or equal to a set fairness index.

The neural network model training method may further include: determining a sampling probability based on a first parameter associated with whether to sample the training data according to a priority; correcting a bias value of the sampling probability using a weight based on a second parameter that increases linearly with each training step; and sampling the training data using the sampling probability corrected according to the bias value.

According to an example embodiment of the present disclosure, an electronic device may be a device of one of various types. The electronic device may include, as non-limiting examples, a portable communication device (e.g., a smartphone, etc.), a computing device, a portable multimedia device, a portable medical device, a camera, a wearable device, a home appliance, or the like. However, the electronic device is not limited to the foregoing examples.

It is to be understood that various embodiments of the disclosure and the terms used therein are not intended to limit the technological features set forth herein to particular embodiments and include various changes, equivalents, or replacements for a corresponding embodiment. In connection with the description of the drawings, like reference numerals may be used for similar or related components. It is to be understood that a singular form of a noun corresponding to an item may include one or more of the things unless the relevant context clearly indicates otherwise. As used herein, “A or B,” “at least one of A and B,” “at least one of A or B,” “A, B, or C,” “at least one of A, B, and C,” and “at least one of A, B, or C,” each of which may include any one of the items listed together in the corresponding one of the phrases, or all possible combinations thereof. Terms such as “first” or “second” may simply be used to distinguish the component from other components in question, and do not limit the components in other aspects (e.g., importance or order). It is to be understood that if an element (e.g., a first element) is referred to, with or without the term “operatively” or “communicatively,” as “coupled with,” “coupled to,” “connected with,” or “connected to” another element (e.g., a second element), it denotes that the element may be coupled with the other element directly (e.g., by wire), wirelessly, or via a third element.

As used in connection with certain embodiments of the disclosure, the term “module” may include a unit implemented in hardware, software, or firmware, or any combination thereof, and may interchangeably be used with other terms, for example, “logic,” “logic block,” “part,” or “circuitry.” A module may be a single integral component, or a minimum unit or part thereof, adapted to perform one or more functions. For example, according to an embodiment, the module may be implemented in the form of an application-specific integrated circuit (ASIC).

Various embodiments as set forth herein may be implemented as software (e.g., the program 140) including one or more instructions that are stored in a storage medium (e.g., the internal memory 136 or the external memory 138) that is readable by a machine (e.g., the electronic device 101). For example, a processor (e.g., the processor 120) of the machine (e.g., the electronic device 101) may invoke at least one of the one or more instructions stored in the storage medium and execute it. This allows the machine to be operated to perform at least one function according to the at least one instruction invoked. The one or more instructions may include code generated by a compiler or code executable by an interpreter. The machine-readable storage medium may be provided in the form of a non-transitory storage medium. The “non-transitory” storage medium is a tangible device, and may not include a signal (e.g., an electromagnetic wave), but this term does not differentiate between where data is semi-permanently stored in the storage medium and where the data is temporarily stored in the storage medium.

According to various embodiments of the present disclosure, a method described herein may be included and provided in a computer program product. The computer program product may be traded as a product between a seller and a buyer. The computer program product may be distributed in the form of a machine-readable storage medium (e.g., a compact disc read-only memory (CD-ROM)), or be distributed (e.g., downloaded or uploaded) online via an application store (e.g., PlayStore™), or between two user devices (e.g., smartphones) directly. If distributed online, at least part of the computer program product may be temporarily generated or at least temporarily stored in the machine-readable storage medium, such as a memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration.

According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. An electronic device, comprising:
at least one processor comprising processing circuitry; and
a memory electrically connected to at least one processor and storing instructions executable by at least one processor,
wherein at least one processor, individually and/or collectively, is configured to:
obtain an achievable rate predicted based on resource blocks being allocated to a plurality of terminals, based on channel quality information (CQI) indexes for the plurality of terminals; and
output a schedule allocating the resource blocks to the plurality of terminals by inputting the achievable rate into a trained neural network model,
wherein the neural network model is configured to be trained to:
collect training CQI indexes for the plurality of terminals;
obtain a training achievable rate predicted based on the resource blocks being allocated to the plurality of terminals based on the training CQI indexes; and
output the schedule, using the training achievable rate input, such that a sum throughput for the plurality of terminals is maximized and a fairness index for the plurality of terminals satisfies a set fairness condition.

2. The electronic device of claim 1, wherein
the neural network model is configured to be trained to calculate a ground truth (GT) schedule that maximizes the sum throughput for the plurality of terminals and satisfies the fairness condition based on the achievable rate, and is configured to be trained based on a supervised learning method, using the achievable rate and the GT schedule.

3. The electronic device of claim 1, wherein
the neural network model is configured to be trained based on an unsupervised learning method.

4. The electronic device of claim 3, wherein
the neural network model comprises:
an activation function configured to output the schedule that allows a resource block to be allocated to only one of the plurality of terminals.

5. The electronic device of claim 1, wherein
the neural network model is set such that a magnitude of the sum throughput according to the schedule and a loss have a negative correlation, and
in response to the fairness condition not being satisfied, the fairness index according to the schedule and the loss have a negative correlation.

6. An electronic device, comprising:
at least one processor comprising processing circuitry; and
a memory electrically connected to at least one processor and storing instructions executable by at least one processor,
wherein at least one processor, individually and/or collectively, is configured to:
obtain, based on channel quality information (CQI) indexes for a plurality of terminals, a current state comprising an average throughput of each of the plurality of terminals, a throughput, and an average fairness index for the plurality of terminals; and determine an action for allocating resource blocks to the plurality of terminals based on the current state, using a neural network model trained according to a deep Q-network (DQN) learning method,
wherein the neural network model is configured to be trained to output the action that maximizes a reward in the current state,
wherein the reward is determined based on a reward function according to constraints set for allocating the resource blocks to the plurality of terminals.

7. The electronic device of claim 6, wherein
the constraints require that a sum of respective average throughputs of the plurality of terminals be maximized,
the throughput for the plurality of terminals be greater than or equal to a set quality of service (QOS),
the number of resource blocks to be allocated to each of the plurality of terminals be less than or equal to a set maximum number of resource blocks, and
the average fairness index for the plurality of terminals be greater than or equal to a set fairness index.

8. The electronic device of claim 6, wherein
the reward is determined according to a reward function determined based on a sum of respective average throughputs of the plurality of terminals, the average fairness index for the plurality of terminals, a set QoS, and a set maximum number of resource blocks.

9. The electronic device of claim 6, wherein at least one processor, individually and/or collectively, is configured to:
determine a plurality of subgroups by dividing at least one of the plurality of terminals or the resource blocks based on the number of the plurality of terminals or the number of the resource blocks; and
output the action for each of the plurality of subgroups by inputting the current state of each of the plurality of subgroups into the neural network model.

10. The electronic device of claim 6, wherein
the neural network model is configured to be trained using a Q-network configured to output a Q-value based on the action and a target Q-network for evaluating the action.

11. A scheduling method, comprising:
obtaining, based on channel quality information (CQI) indexes for a plurality of terminals, a current state comprising an average throughput of each of the plurality of terminals, a throughput, and an average fairness index for the plurality of terminals; and
determining an action for allocating resource blocks to the plurality of terminals based on the current state, using a neural network model trained according to a deep Q-network (DQN) learning method,
wherein the neural network model is trained to output the action that maximizes a reward in the current state,
wherein the reward is determined based on a reward function according to constraints set for allocating the resource blocks to the plurality of terminals.

12. The scheduling method of claim 11, wherein
the constraints require that a sum of respective average throughputs of the plurality of terminals be maximized,
the throughput for the plurality of terminals be greater than or equal to a set quality of service (QOS),
the number of resource blocks to be allocated to each of the plurality of terminals be less than or equal to a set maximum number of resource blocks, and
the average fairness index for the plurality of terminals be greater than or equal to a set fairness index.

13. The scheduling method of claim 11, wherein
the reward is determined according to a reward function determined based on a sum of respective average throughputs of the plurality of terminals, the average fairness index for the plurality of terminals, a set QoS, and a set maximum number of resource blocks.

14. The scheduling method of claim 11, further comprising:
determining a plurality of subgroups by dividing at least one of the plurality of terminals or the resource blocks, based on the number of the plurality of terminals or the number of the resource blocks,
wherein the determining of the action comprises:
outputting the action for each of the plurality of subgroups by inputting the current state of each of the plurality of subgroups into the neural network model.

15. The scheduling method of claim 11, wherein
the neural network model is configured to be trained using a Q-network for outputting the action and a target network for evaluating the action, with a double DQN (DDQN) model.
